(19) United States
(12) Patent Application Publication
(10) Pub. No.: US 2009/0177527 A1
(43) Pub. Date: Jul. 9, 2009

(54) Rewarding influencers

(76) Inventors: Gary W. Flake, Bellevue, WA (US); William H. Gates, III, Redmond, WA (US); Alexander G. Gounares, Kirkland, WA (US); W. Daniel Hillis, Encino, CA (US); Royce A. Levien, Lexington, MA (US); Mark A. Malamud, Seattle, WA (US); Craig J. Mundie, Seattel, WA (US); Christopher D. Payne, Seattle, WA (US); Richard F. Rashid, Redmond, WA (US); Clarence T. Tegreene, Bellevue, WA (US); Charles Whitmer, North Bend, WA (US); Lowell L. Wood, JR., Bellevue, WA (US)

Correspondence Address: Constellation Law Group, PLLC, P.O. Box 220, Tracyton, WA, 98393, US

(21) Appl. No.: 12/290,310

(22) Filed: Oct. 28, 2008

Related U.S. Application Data
(63) Continuation-in-part of application No. 11/799,460, filed on Apr. 30, 2007.
Application No. 11/799,460 is a continuation-in-part of application No. 11/811,349, filed on Jun. 7, 2007.
Application No. 11/811,349 is a continuation-in-part of application No. 11/799,461, filed on Apr. 30, 2007.
Application No. 11/799,461 is a continuation-in-part of application No. 11/811,402, filed on Jun. 8, 2007.
Application No. 11/811,402 is a continuation-in-part of application No. 11/824,551, filed on Jun. 29, 2007.
Application No. 11/824,551 is a continuation-in-part of application No. 11/906,537, filed on Oct. 1, 2007.
Application No. 11/906,537 is a continuation-in-part of application No. 11/824,580, filed on Jun. 29, 2007.
Application No. 11/824,580 is a continuation-in-part of application No. 11/881,800, filed on Jul. 27, 2007.
Application No. 11/881,800 is a continuation-in-part of application No. 11/906,780, filed on Oct. 2, 2007.

(51) Int. Cl. G06Q 30/00; G06Q 10/00

(52) U.S. Cl. 705/10; 705/14

(57) ABSTRACT

The present disclosure relates generally to rewarding influencers in a Web 2.0 environment. More specifically, in some implementations, an influence of an electronically-accessed content on an involvement between an accessor and a third party is assessed. In further implementations, a provider of the electronically accessed content is rewarded based on the assessed influence.

### CROSS REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)):

### RELATED APPLICATIONS

For purposes of the United States Patent and Trademark Office (USPTO) extra-statutory requirements (described more fully below), the present application constitutes:

1. A continuation-in-part application of U.S. patent application Ser. No. 11/799,460 entitled REWARDING INFLUENCERS, naming Gary W. Flake, William H. Gates, III, Alexander G. Gounares, W. Daniel Hillis, Royce A. Levien, Mark A. Malamud, Craig J. Mundie, Christopher D. Payne, Richard F. Rashid, Clarence T. Tegreene, Charles Whitmer, and Lowell L. Wood, Jr. as inventors, filed 30 Apr. 2007, which is currently co-pending, or is an application of which a currently co-pending application is entitled to the benefit of the filing date.

2. A continuation-in-part application of U.S. patent application Ser. No. 11/811,349 entitled REWARDING INFLUENCERS, naming Gary W. Flake, William H. Gates, III, Alexander G. Gounares, W. Daniel Hillis, Royce A. Levien, Mark A. Malamud, Craig J. Mundie, Christopher D. Payne, Richard F. Rashid, Clarence T. Tegreene, Charles Whitmer, and Lowell L. Wood, Jr. as inventors, filed 7 Jun. 2007, which is currently co-pending, or is an application of which a currently co-pending application is entitled to the benefit of the filing date.

3. A continuation-in-part application of U.S. patent application Ser. No. 11/799,461 entitled DETERMINING INFLUENCERS, naming Gary W. Flake, William H. Gates, III, Alexander G. Gounares, W. Daniel Hillis, Royce A. Levien, Mark A. Malamud, Craig J. Mundie, Christopher D. Payne, Richard F. Rashid, Clarence T. Tegreene, Charles Whitmer, and Lowell L. Wood, Jr. as inventors, filed 30 Apr. 2007, which is currently co-pending, or is an application of which a currently co-pending application is entitled to the benefit of the filing date.

4. A continuation-in-part application of U.S. patent application Ser. No. 11/811,402 entitled DETERMINING INFLUENCERS, naming Gary W. Flake, William H. Gates, III, Alexander G. Gounares, W. Daniel Hillis, Royce A. Levien, Mark A. Malamud, Craig J. Mundie, Christopher D. Payne, Richard F. Rashid, Clarence T. Tegreene, Charles Whitmer, and Lowell L. Wood, Jr. as inventors, filed 8 Jun. 2007, which is currently co-pending, or is an application of which a currently co-pending application is entitled to the benefit of the filing date.

5. A continuation-in-part application of U.S. patent application Ser. No. 11/824,551 entitled REPORTING INFLUENCE ON A PERSON BY NETWORK-AVAILABLE CONTENT filed Jun. 29, 2007 under Attorney Docket No. 1206-003-003-000000, which is currently co-pending, or is an application of which a currently co-pending application is entitled to the benefit of the filing date.

6. A continuation-in-part application of U.S. patent application Ser. No. 11/824,582 entitled COLLECTING INFLUENCE INFORMATION, naming Gary W. Flake, William H. Gates, III, Alexander G. Gounares, W. Daniel Hillis, Royce A. Levien, Mark A. Malamud, Craig J. Mundie, Christopher D. Payne, Richard F. Rashid, Clarence T. Tegreene, Charles Whitmer, and Lowell L. Wood, Jr. as inventors, filed 29 Jun. 2007, which is currently co-pending, or is an application of which a currently co-pending application is entitled to the benefit of the filing date.

7. A continuation-in-part application of U.S. patent application Ser. No. 11/906,537 entitled COLLECTING INFLUENCE INFORMATION, naming Gary W. Flake, William H. Gates, III, Alexander G. Gounares, W. Daniel Hillis, Royce A. Levien, Mark A. Malamud, Craig J. Mundie, Christopher D. Payne, Richard F. Rashid, Clarence T. Tegreene, Charles Whitmer, and Lowell L. Wood, Jr. as inventors, filed 1 Oct. 2007, which is currently co-pending, or is an application of which a currently co-pending application is entitled to the benefit of the filing date.

8. A continuation-in-part application of U.S. patent application Ser. No. 11/824,580 entitled DETERMINING AN INFLUENCE ON A PERSON BY WEB PAGES, naming Gary W. Flake, William H. Gates, III, Alexander G. Gounares, W. Daniel Hillis, Royce A. Levien, Mark A. Malamud, Craig J. Mundie, Christopher D. Payne, Richard F. Rashid, Clarence T. Tegreene, Charles Whitmer, and Lowell L. Wood, Jr. as inventors, filed 29 Jun. 2007, which is currently co-pending, or is an application of which a currently co-pending application is entitled to the benefit of the filing date.

9. A continuation-in-part application of U.S. patent application Ser. No. 11/881,800 entitled REWARDING INDEPENDENT INFLUENCERS, naming Gary W. Flake, William H. Gates, III, Alexander G. Gounares, W. Daniel Hillis, Royce A. Levien, Mark A. Malamud, Craig J. Mundie, Christopher D. Payne, Richard F. Rashid, Clarence T. Tegreene, Charles Whitmer, and Lowell L. Wood, Jr. as inventors, filed 27 Jul. 2007, which is currently co-pending, or is an application of which a currently co-pending application is entitled to the benefit of the filing date.

10. A continuation-in-part application of U.S. patent application Ser. No. 11/906,780 entitled REWARDING INDEPENDENT INFLUENCERS, naming Gary W. Flake, William H. Gates, III, Alexander G. Gounares, W. Daniel Hillis, Royce A. Levien, Mark A. Malamud, Craig J. Mundie, Christopher D. Payne, Richard F. Rashid, Clarence T. Tegreene, Charles Whitmer, and Lowell L. Wood, Jr. as inventors, filed 2 Oct. 2007, which is currently co-pending, or is an application of which a currently co-pending application is entitled to the benefit of the filing date.

The United States Patent and Trademark Office (USPTO) has published a notice to the effect that the USPTO's computer programs require that patent applicants reference both a serial number and indicate whether an application is a continuation or continuation in part. Stephen G. Kunin, Benefit of Prior-Filed Application, USPTO Electronic Official Gazette, Mar. 18, 2003. The present applicant entity has provided a specific reference to the application(s) from which priority is being claimed as recited by statute. Applicant entity understands that the statute is unambiguous in its specific reference language and does not require either a serial number or any characterization such as “continuation” or “continuation-in-part.” Notwithstanding the foregoing, applicant entity understands that the USPTO's computer programs have certain data entry requirements, and hence applicant entity is designating the present application as a continuation in part of its parent applications, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### FIELD OF THE DISCLOSURE

The present disclosure relates generally to rewarding influencers in a Web 2.0 environment. More specifically, in some implementations, an influence of an electronically-accessed content on an involvement between an accessor and a third party is assessed. In further implementations, a provider of the electronically accessed content is rewarded based on the assessed influence.

### BACKGROUND

As the communication network commonly known as the Web (or Internet) continues to evolve, contemporary web development efforts are being directed toward improved Web-based applications that improve user interaction, functionality, and utility. These development efforts, widely referred to as “Web 2.0,” are leading to a surge of innovation and are resulting in a rapid evolution of the means through which electronic content is being provided and accessed on the Web. While desirable results are being achieved, there remains a need to incentivize providers of electronically accessed content.

### SUMMARY

The present disclosure relates generally to rewarding influencers, and more specifically, to assessing an influence of an electronically accessed content on an involvement between an accessor and a third party. In some implementations, the assessment of the influence may be performed in a Web 2.0 environment, and a provider of the electronically accessed content may be rewarded based on the assessed influence.

### BRIEF DESCRIPTION OF THE DRAWINGS

FIG. 1 illustrates an exemplary embodiment of a thin computing device in which embodiments may be implemented;

FIG. 2 illustrates an exemplary embodiment of a general-purpose computing system in which embodiments may be implemented;

FIG. 3 illustrates another exemplary system in which embodiments may be implemented;

FIG. 4 illustrates an exemplary network environment in which embodiments may be implemented; and

FIGS. 5 through 40 are flowcharts of methods of assessing an influence of an electronically accessed content in accordance with various implementations of the present disclosure.

### DETAILED DESCRIPTION

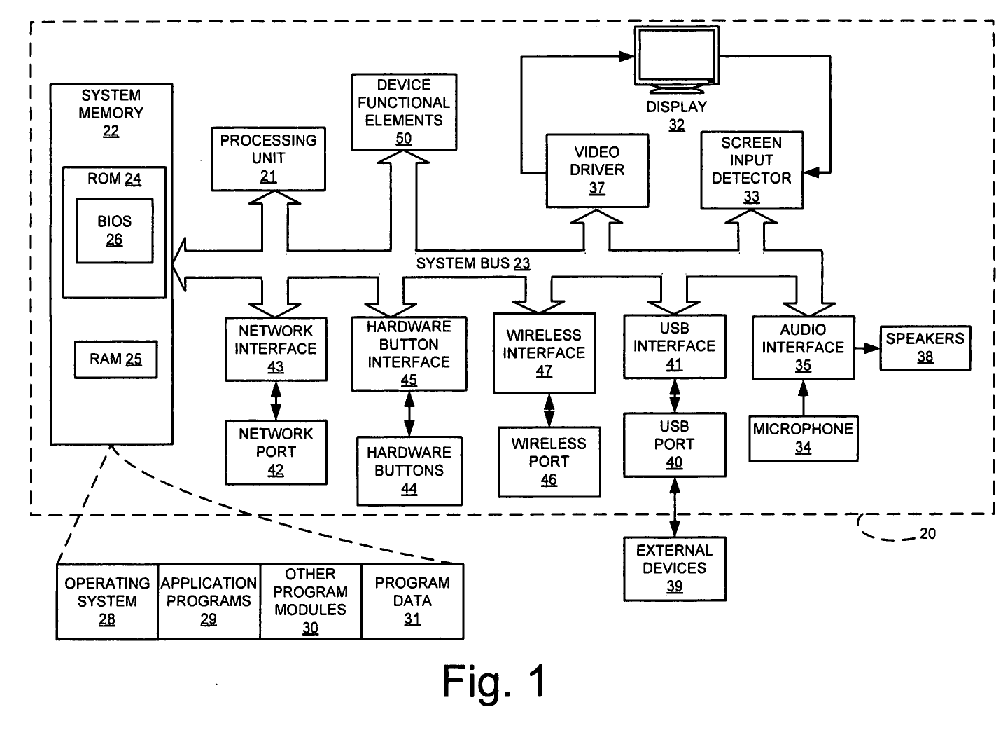

Techniques for rewarding influencers, and more specifically, to assessing an influence of an electronically accessed content on an involvement between an accessor and a third party, are disclosed. It should be appreciated that many specific details of certain implementations are set forth in the following description, and in FIGS. 1 through 36 to provide a thorough understanding of such implementations. One skilled in the art will understand from the teachings of the present disclosure, however, that the present disclosure may have other possible implementations, and that such other implementations may be practiced with/without some of the details set forth in the following description.

Exemplary Environments

Exemplary environments in which various implementations in accordance with the present disclosure may be implemented are described in this section with reference to FIGS. 1 through 4. It will be appreciated, however, that the following description of exemplary environments is not exhaustive of all possible environments in which the teachings of the present disclosure may be implemented.

For example, FIG. 1 illustrates an exemplary system that includes a thin computing device 20, which may be included in an electronic device that also includes a device functional element 50. For example, the electronic device may include any item having electrical and/or electronic components playing a role in a functionality of the item, such as a limited resource computing device, an electronic pen, a handheld electronic writing device, a digital camera, a scanner, an ultrasound device, an x-ray machine, a non-invasive imaging device, a cell phone, a printer, a refrigerator, a car, and an airplane. The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 and/or RAM 25, including an operating system 28, one or more application programs 29, other program modules 30 and program data 31.

A user may enter commands and information into the computing device 20 through input devices, such as a number of switches and buttons, illustrated as hardware buttons 44, connected to the system via a suitable interface 45. Input devices may further include a touch-sensitive display screen 32 with suitable input detection circuitry 33. The output circuitry of the touch-sensitive display 32 is connected to the system bus 23 via a video driver 37. Other input devices may include a microphone 34 connected through a suitable audio interface 35, and a physical hardware keyboard (not shown). In addition to the display 32, the computing device 20 may include other peripheral output devices, such as at least one speaker 38.

Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are exemplary and other components and means of establishing communications links may be used.

The computing device 20 may be primarily designed to include a user interface. The user interface may include a character, a key-based, and/or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and is coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, and a camera capturing and saving an image.

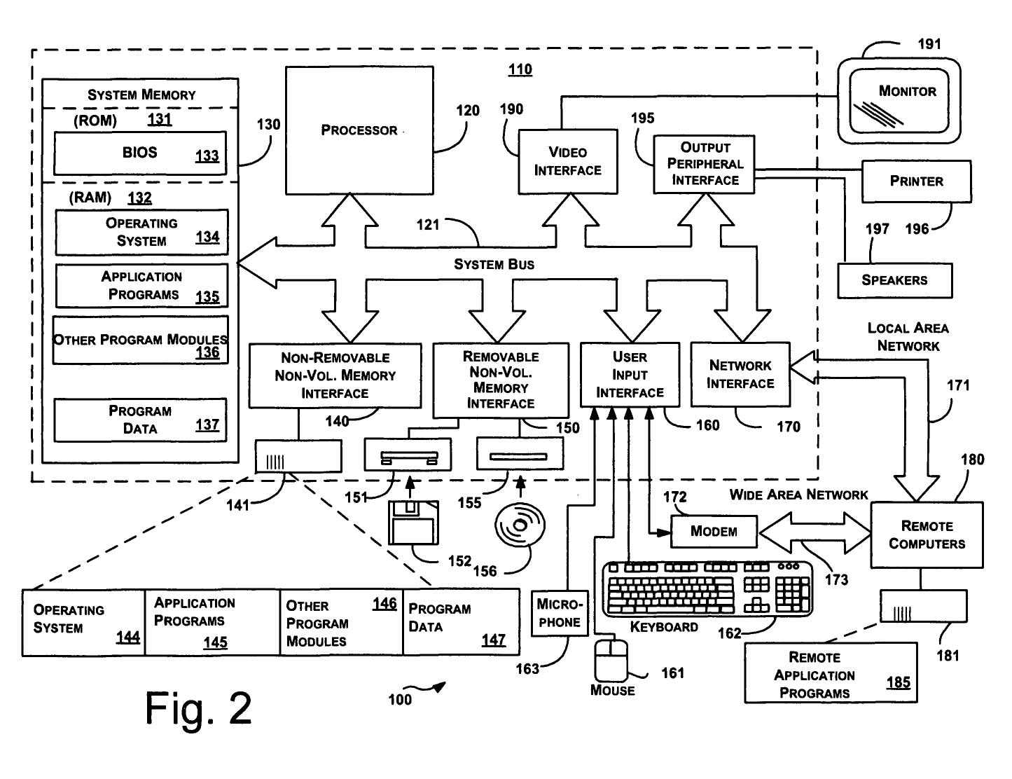

FIG. 2 illustrates an exemplary embodiment of a general-purpose computing system in which embodiments may be implemented, shown as a computing system environment 100. Components of the computing system environment 100 may include, but are not limited to, a computing device 110 having a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, and/or atomic quantum memory. Combinations of any of the above may also be included within the scope of computer-readable media.

Communications media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media such as a wired network and a direct-wired connection and wireless media such as acoustic, RF, optical, and infrared media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, and/or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by processing unit 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, and/or is coupled to an optical disk drive 155 that reads from and writes to a removable, non-volatile optical disk 156, such as a CD ROM. Other removable/nonremovable, volatile/non-volatile computer storage media that can be used in the exemplary operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies. A user may enter commands and information into the computing device 110 through input devices such as a microphone 163, keyboard 162, and pointing device 161, commonly referred to as a mouse, trackball, or touch pad. Other input devices (not shown) may include a joystick, game pad, satellite dish, and scanner. These and other input devices are often connected to the processing unit 120 through a user input interface 160 that is coupled to the system bus, but may be connected by other interface and bus structures, such as a parallel port, game port, or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The logical connections depicted in FIG. 2 include a local area network (LAN) 171 and a wide area network (WAN) 173, but may also include other networks such as a personal area network (PAN) (not shown). Such networking environments are commonplace in offices, enterprise-wide computer networks, intranets, and the Internet.

When used in a LAN networking environment, the computing system environment 100 is connected to the LAN 171 through a network interface or adapter 170. When used in a WAN networking environment, the computing device 110 typically includes a modem 172 or other means for establishing communications over the WAN 173, such as the Internet. The modem 172, which may be internal or external, may be connected to the system bus 121 via the user input interface 160, or via another appropriate mechanism. In a networked environment, program modules depicted relative to the computing device 110, or portions thereof, may be stored in a remote memory storage device. By way of example, and not limitation, FIG. 2 illustrates remote application programs 185 as residing on computer storage medium 181. It will be appreciated that the network connections shown are exemplary and other means of establishing communications link between the computers may be used.

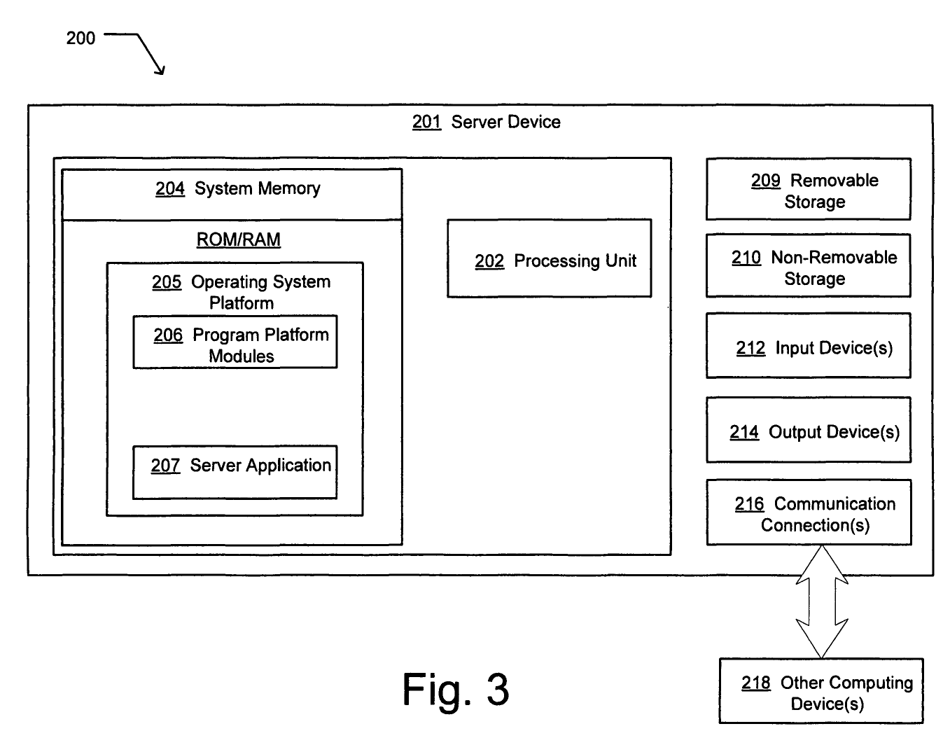

FIG. 3 illustrates an exemplary system 200 in which embodiments may be implemented. The exemplary system includes a computing system couplable to a network and operable to provide electronic content, such as a server 201. In an embodiment, the server may include an application server, audio server, database server, fax server, file server, intranet server, mail server, merchant server, modem server, network access server, network server, print server, proxy server, remote access server, telephony server, terminal server, video server, and/or Web server. In another embodiment, the server may include a network intermediary, a network switch, and/or a router. Server functionality may be implemented in software, hardware, firmware, and/or a combination thereof. Server functionality may be provided by a computing device that also provides other functionality. The network may include an electronic network, an optical network, and/or a combination of optical and electronic networks.

In a configuration, the server 201 typically includes at least one processing unit 202 and system memory 204. System memory 204 typically includes operating system platform 205 and one or more program modules 206 running on operating system. In addition to the program modules 206, a server application 207 may also be running on the operating system. The server application 207 may be operable to deliver electronic content and/or files to applications via a protocol, and may include and/or interact with other computing devices, application servers, applications, and application interfaces (APIs) residing in other applications. For example, the server application may include a Web server operable to deliver Web pages and/or electronic content to Web browser applications via HTTP protocols.

The server 201 may have additional features or functionality. For example, server may also include additional data storage devices (removable and/or non-removable), as illustrated in FIG. 3 by removable storage 209 and non-removable storage 210. System memory 204, removable storage 209 and non-removable storage 210 are all examples of computer storage media. The server may include input device(s) 212 and output device(s) 214. The server also contains communication connections 216 that allow the device to communicate with and perform a service associated with a network, including communicating with other servers and/or with other computing device, illustrated as other computing device(s) 218. Communication connections 216 are one example of communication media.

FIGS. 1-3 are intended to provide a brief, general description of an illustrative and/or suitable exemplary environments in which embodiments may be implemented. An exemplary system may include the thin computing device 20 of FIG. 1, the computing system environment 100 of FIG. 2, and/or the server of FIG. 3. FIGS. 1-3 are examples of a suitable environment and is not intended to suggest any limitation as to the structure, scope of use, or functionality of an embodiment. A particular environment should not be interpreted as having any dependency or requirement relating to any one or combination of components illustrated in an exemplary environment. For example, in certain instances, one or more elements of an environment may be deemed not necessary and omitted. In other instances, one or more other elements may be deemed necessary and added. Further, it will be appreciated that device(s) and/or environment(s) described herein may include numerous electrical, optical, mechanical, and/or digital components that may necessary to operate the device, but are not needed to illustrate the subject matter described herein. As such, some of these electrical, optical, mechanical, and/or digital components may be omitted from the specification for clarity.

In the description that follows, certain embodiments may be described with reference to acts and symbolic representations of operations that are performed by one or more computing devices, such as the computing device 110 of FIG. 2. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

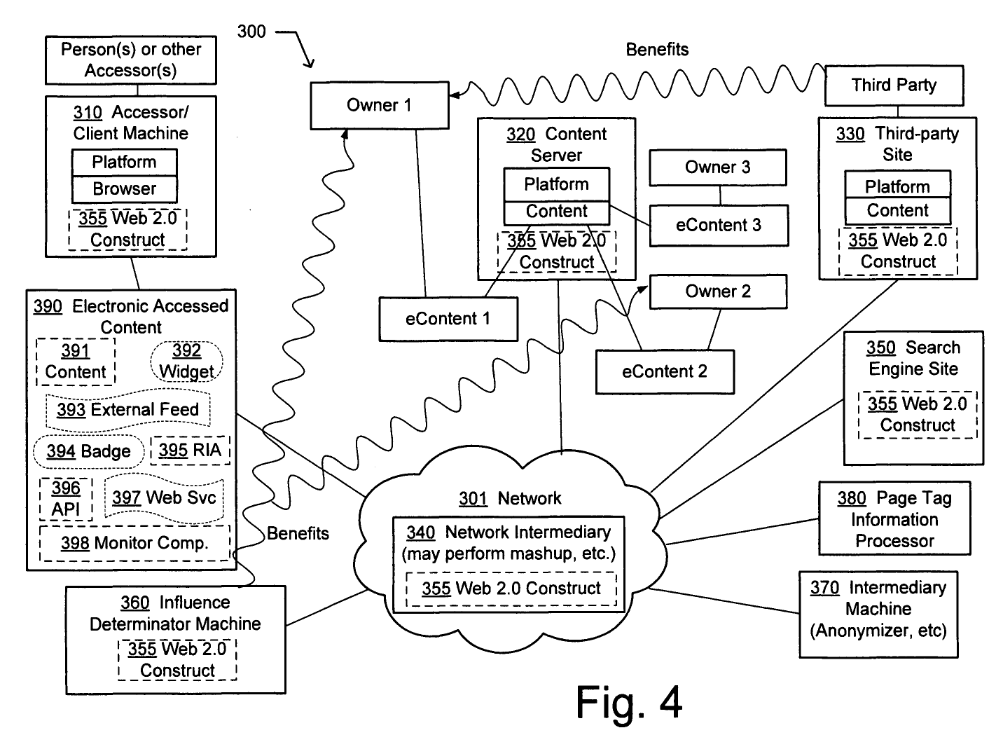

FIG. 4 illustrates an exemplary network environment 300 in which embodiments may be implemented. The exemplary environment may include one or more networks, illustrated as a network 301, and one or more client (or accessor) machines, illustrated as client (or accessor_machine 310. A fabric of the network 301 may include network intermediaries, illustrated as a network intermediary 340 running on a platform (not shown). In an embodiment, the client machine includes a computing device used by a human user. In another embodiment, the client machine includes a computing device used by a human user to communicate in a peer-to-peer environment (P2P), and/or to communicate in a cloud-to-cloud environment (C2C). In a further embodiment, the client machine includes a computing device used by a human user to communicate with a server. The client machine may include the thin computing device 20 illustrated in FIG. 1, and/or the computing device 110 illustrated in FIG. 2.

The exemplary environment 300 may also include one or more servers, illustrated as a content server 320. In an embodiment, the content server is operable to provide electronic content (illustrated as eContent 1 and/or eContent 2 to one or more client machines. In another embodiment, the content server includes the server 201 illustrated in FIG. 3. In a further embodiment, the content server(s) includes a node in P2P and/or a C2C network. The node may include the thin computing device 20 illustrated in FIG. 1, and/or the computing device 110 illustrated in FIG. 2. The exemplary environment 300 may also include one or more third-party sites, illustrated as a third-party site 330. The third-party site may include a merchant site, such as amazon.com for books, a manufacturer site, such as subaru.com for automobiles, a religious institution, such as catholic.org and/or hinduism.com, and/or a political site, such as mc.org and/or democrats.org. The exemplary environment 300 may also include one or more search engine sites, illustrated as a search engine site 350. The search engine site may include a general search engine site, such as google.com and/or live.com. In another embodiment, the search engine site may include a topical search site, such as HONMedhunt and/or FindLaw.com.

The exemplary environment 300 may also include an influence determinator machine 360, an intermediary machine 370, and/or a page tag information processor 380. Each of these machines may be operable to receive data and/or information gathered by at least one of the client machine 310, the content server 320, the third-party site 330, and/or the network intermediary 340, and to produce an output useable in assessing an influence on a person using the client machine by a content of the content server.

As further shown in FIG. 4, one or more components of the network environment 300 may cooperatively provide an electronic accessed content 390 that may be accessed by the accessor (or client) machine 310. In some implementations, the electronic accessed content 390 may include one or more portions or components. For example, in some implementations, the electronic accessed content 390 may include a mashup of similar or different portions or components, or a plurality of mashups.

More specifically, with continued reference to FIG. 4, in some implementations, the electronic accessed content 390 may include one or more of the following components or types: a content 391 (e.g. text, audio, visual, video, or other suitable content), a widget 392 (e.g. clock, weather monitor, music provider, news provider, game, entertainment provider, story provider, article provider, stock market tracker, etc.), an external feed 393 (e.g. clock, weather monitor, music provider, news provider, game, entertainment provider, story provider, article provider, stock market tracker, etc.), a badge 394 (e.g. animal, brand name, musical group, sports content, humorous content, entertainment content, nationality content, religious content, affinity content, affiliation content, etc.), a Rich Internet Application (RIA) 395 (e.g. virtual weather provider, virtual experience provider, news provider, designer, entertainment provider, shopping facilitator, analytical facilitator, etc.), an Application Programming Interface (API) 396 (e.g. file operations, file references, geometry and topology operations, feature operations, projects, drawing and dimensional operations, assembly operations, user interfaces, user preferences, etc.), a web service 397 (e.g. search service, mapping service, directions service, spelling and grammar services, etc.), and a monitoring component 398 (e.g. tracking component, access monitor, registration component, etc.). Of course, in alternate implementations, the electronic accessed content 390 may include any other suitable components or content types.

The network environment 300 further includes one or more Web 2.0 constructs 355 which may be located or distributed on one or more components within the environment 300. For example, in some implementations, a Web 2.0 construct 355 may be located on the network 301, the accessor/client machine 310, the content server 320, the third-party site 330, the network intermediary 340, the search engine site 350, the influence determinator machine 360, or any other component of the network environment 300. As used herein, the term “Web 2.0 construct” (or “machine-implemented Web 2.0 construct”) may include a wide variety of constructs implemented in software, hardware, firmware, or combinations thereof. For example, a “Web 2.0 construct” may include a web-based application, a web service, an asynchronous application, an API, an RIA application, an Ajax (Asynchronous JavaScript and XML (Extensible Markup Language)) application, a Flex application, a Flash® application, a Web 2.0 engine, or a mashup that includes one or more of the afore-mentioned constructs.

Various functional and operational aspects of the components of the networked environment 300 are discussed in the sections below. It should be appreciated, however, that the exemplary systems and environments described above with reference to FIGS. 1-4 are merely illustrative of a few possible systems and environments in which the teachings of the present disclosure may be implemented, and that the teachings herein are not limited to the particular systems and environments described above.

Exemplary Processes for Rewarding Influencers

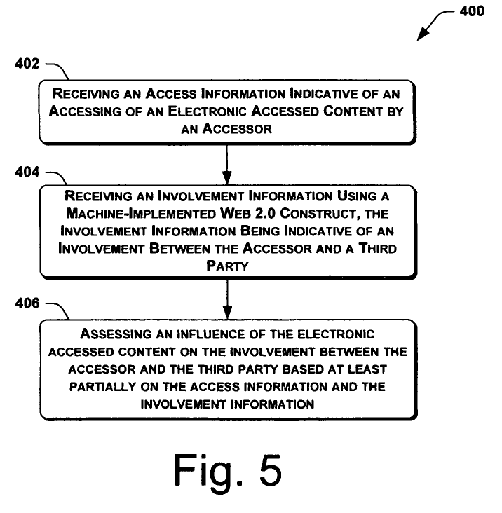

Exemplary processes for rewarding influencers in accordance with the teachings of the present disclosure are described below with reference to FIGS. 5 through 40. It will be appreciated, however, that the following description of exemplary processes is not exhaustive of all possible processes in accordance with the teachings of the present disclosure.

For example, FIG. 5 is a flowchart of method 400 of assessing an influence of an electronically accessed content in accordance with the present disclosure. More specifically, in this implementation, the method 400 includes receiving an access information indicative of an accessing of an electronic accessed content by an accessor at 402. For example, in a representative implementation, receiving an access information indicative of an accessing of an electronic accessed content by an accessor at 402 may include receiving data indicating that a web browser associated with a particular consumer has accessed a particular website for a particular duration of time, or that a mobile device (e.g. cellular telephone) has requested a download of a particular podcast of information.

The method 400 further includes receiving an involvement information using a machine-implemented Web 2.0 construct, the involvement information being indicative of an involvement between the accessor and a third party at 404. In some implementations, the receiving an involvement information using a machine-implemented Web 2.0 construct, the involvement information being indicative of an involvement between the accessor and a third party at 404 may include, for example, receiving data indicating that the above-mentioned consumer conducted a transaction with a particular vendor of goods or services, or that a user of the aforesaid cellular telephone conducted business with a broker. It will be appreciated that a wide variety of machine-implemented Web 2.0 constructs may be used for receiving the involvement information at 404, including, for example, an Ajax (Asynchronous JavaScript and XML (Extensible Markup Language)) application, an asynchronous application, a Flash® application, a web service, any other suitable Web 2.0 engine (or content or construct), or a mashup that includes one or more of the afore-mentioned constructs.

As further shown in FIG. 5, the method 400 also includes assessing an influence of the electronic accessed content on the involvement between the accessor and the third party based at least partially on the access information and the involvement information at 406. For example, in a representative implementation, the assessing an influence of the electronic accessed content on the involvement between the accessor and the third party based at least partially on the access information and the involvement information at 406 may include assessing whether the website accessed by the consumer using the browser was the primary reason the consumer purchased the good or service from the vendor, or assessing whether the cell phone user's interaction with the broker was attributable to the podcast that was downloaded by the user. Of course, many other representative scenarios in accordance with the method 400 may be conceived.

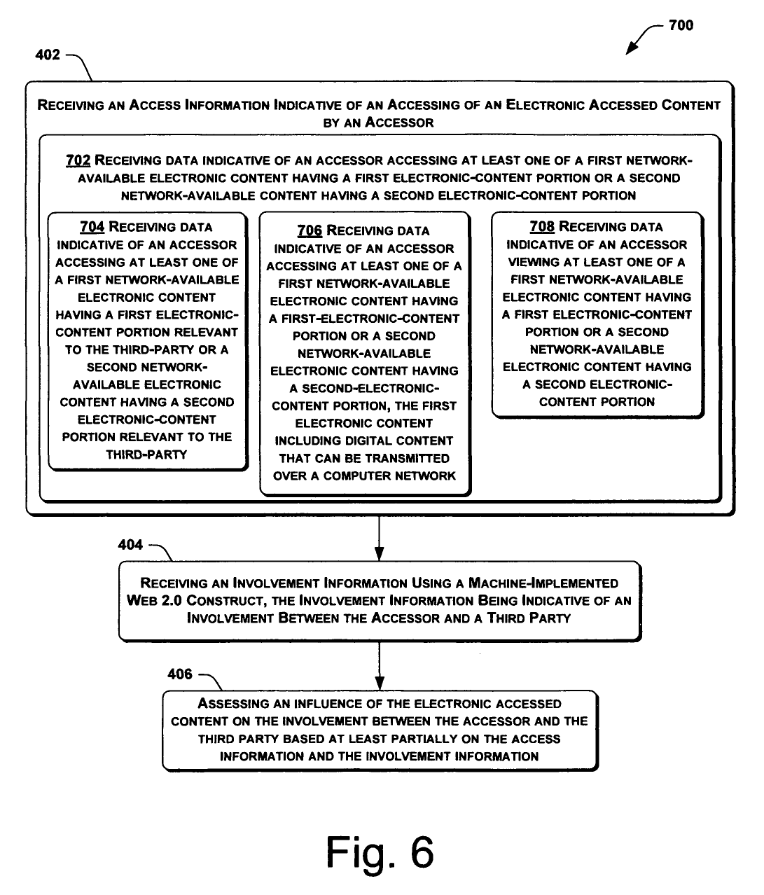

It will be appreciated that receiving the access information at 402 may occur in a variety of ways. For example, in a method 700 as shown in FIG. 6, receiving an access information indicative of an accessing of an electronic accessed content by an accessor may include receiving data indicative of an accessor accessing at least one of a first network-available electronic content having a first electronic-content portion or a second network-available electronic content having a second electronic-content portion at 702 (e.g. receiving data indicative of an accessing of a mashup of a web service-related content and a blog-related content).

More specifically, receiving data indicative of an accessor accessing at least one of a first network-available electronic content having a first electronic-content portion or a second network-available electronic content having a second electronic-content portion (at 702) may include receiving data indicative of an accessor accessing at least one of a first network-available electronic content having a first electronic-content portion relevant to the third-party or a second network-available electronic content having a second electronic-content portion relevant to the third-party at 704. For example, data may be received indicative of a consumer accessing a first product-related content comparing a first brand of cameras (Brand A) to a second brand of cameras (Brand B), and also indicative of the consumer assessing a second product-related content comparing the first and second brands of cameras (Brand A and B), the third party being a provider (e.g. manufacturer, wholesaler, retailer, advertiser, etc.) of either the Brand A camera or the Brand B camera.

Similarly, receiving data indicative of an accessor accessing at least one of a first network-available electronic content having a first electronic-content portion or a second network-available electronic content having a second electronic-content portion (at 702) may include receiving data indicative of an accessor accessing at least one of a first network-available electronic content having a first-electronic-content portion or a second network-available electronic content having a second-electronic-content portion, the first electronic content including digital content that can be transmitted over a computer network at 706 (e.g. receiving data indicative of a searchbot accessing a first webpage or a second webpage, the first webpage including digitized audio signals that are transmitted over the Internet). In some implementations, receiving data indicative of an accessor accessing at least one of a first network-available electronic content having a first electronic-content portion or a second network-available electronic content having a second electronic-content portion (at 702) may include receiving data indicative of an accessor viewing at least one of a first network-available electronic content having a first electronic-content portion or a second network-available electronic content having a second electronic-content portion at 708 (e.g. receiving data indicative of a media player viewing a mashup that provides a first viewable podcast and a second viewable podcast).

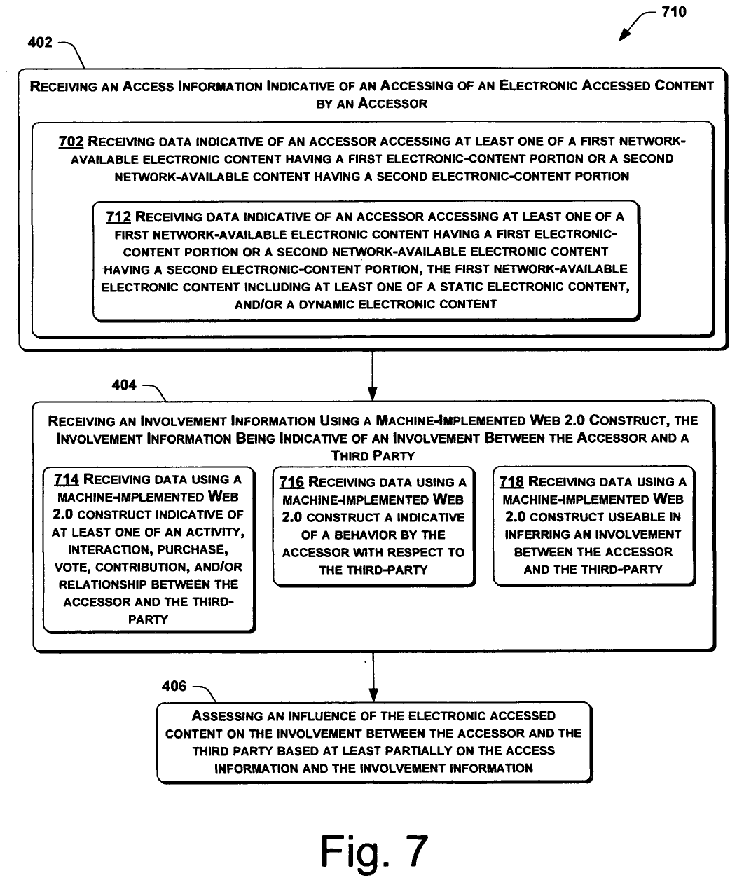

In addition, as depicted by process 710 shown in FIG. 7, in some implementations, receiving data indicative of an accessor accessing at least one of a first network-available electronic content having a first electronic-content portion or a second network-available electronic content having a second electronic-content portion (at 702) may include receiving data indicative of an accessor accessing at least one of a first network-available electronic content having a first electronic-content portion or a second network-available electronic content having a second electronic-content portion, the first network-available electronic content including at least one of a static electronic content, and/or a dynamic electronic content at 712 (e.g. receiving data indicative of a browser accessing a webpage that provides a mashup of a sports team's schedule (static content) and an RSS feed of statistics and scores from the games that are or have been occurring throughout the country (dynamic content)).

It will be appreciated that receiving the involvement information at 404 may be accomplished in a variety of ways. For example, as further shown in FIG. 7, receiving an involvement information using a machine-implemented Web 2.0 construct, the involvement information being indicative of an involvement between the accessor and a third party (at 404) may include receiving data using a machine-implemented Web 2.0 construct indicative of at least one of an activity, interaction, purchase, vote, contribution, and/or relationship between the accessor and the third-party at 714 (e.g. receiving involvement data using an asynchronous application indicative of a purchase-and-sale transaction between a consumer and a vendor). Similarly, receiving an involvement information using a machine-implemented Web 2.0 construct, the involvement information being indicative of an involvement between the accessor and a third party (at 404) may include receiving data using a machine-implemented Web 2.0 construct indicative of a behavior by the accessor with respect to the third-party at 716 (e.g. receiving involvement data using a mashup that indicates that a person recommended the services of an insurance provider to a friend).

In further implementations, receiving an involvement information using a machine-implemented Web 2.0 construct, the involvement information being indicative of an involvement between the accessor and a third party (at 404) may include receiving data using a machine-implemented Web 2.0 construct useable in inferring an involvement between the accessor and the third-party at 718 (e.g. receiving data using an Ajax application that shows a cookie indicative of a consumer transaction was placed by the third-party's website on the accessor's device).

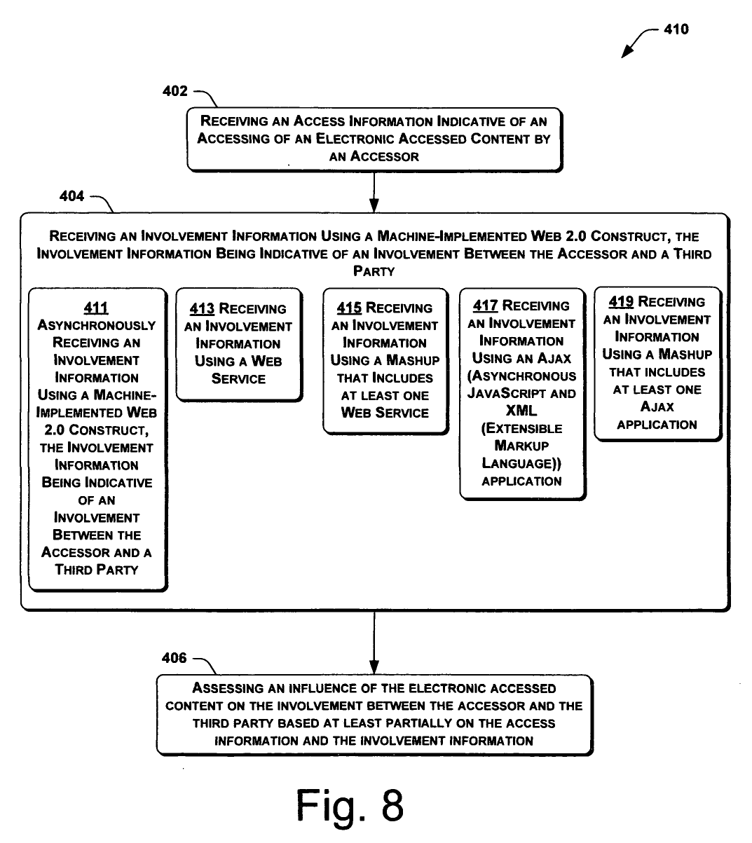

Furthermore, in a method 410 as shown in FIG. 8, receiving an involvement information using a machine-implemented Web 2.0 construct, the involvement information being indicative of an involvement between the accessor and a third party (at 404) may include asynchronously receiving an involvement information using a machine-implemented Web 2.0 construct, the involvement information being indicative of an involvement between the accessor and a third party at 411 (e.g. using an Ajax application or other asynchronous engine). In some implementations, receiving an involvement information using a machine-implemented Web 2.0 construct, the involvement information being indicative of an involvement between the accessor and a third party (at 404) may include receiving an involvement information using a web service at 413 (e.g. a web service that performs tracking and reporting of durations of time spent by web browsers accessing websites). Similarly, in some implementations, receiving an involvement information using a machine-implemented Web 2.0 construct, the involvement information being indicative of an involvement between the accessor and a third party (at 404) may include receiving an involvement information using a mashup that includes at least one web service at 415 (e.g. a mashup that provides both an Internet search service and a web service that performs tracking and reporting of durations of time spent by web browsers accessing websites).

In further implementations, receiving an involvement information using a machine-implemented Web 2.0 construct, the involvement information being indicative of an involvement between the accessor and a third party (at 404) may include receiving an involvement information using an Ajax (Asynchronous JavaScript and XML (Extensible Markup Language)) application at 417 (e.g. an Ajax application that documents and reports podcasts downloaded to a platform or device). Similarly, in some implementations, receiving an involvement information using a machine-implemented Web 2.0 construct, the involvement information being indicative of an involvement between the accessor and a third party (at 404) may include receiving an involvement information using a mashup that includes at least one Ajax application at 419 (e.g. a mashup that includes both an offer to sell printed materials and an Ajax application that documents and reports podcasts downloaded to a platform or device).

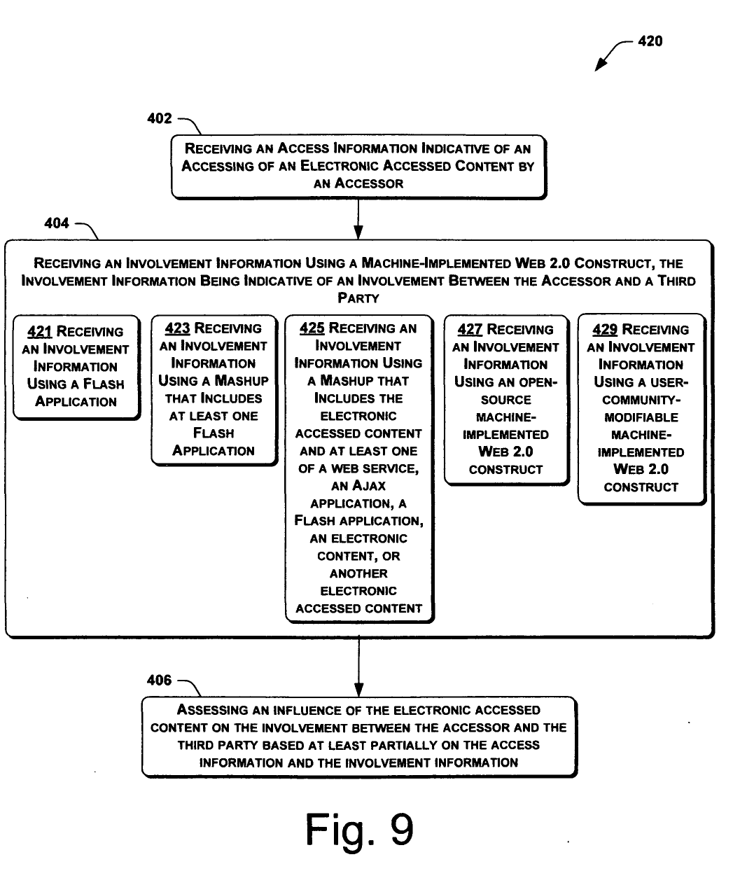

As depicted in the process 420 shown in FIG. 9, in some implementations, receiving an involvement information using a machine-implemented Web 2.0 construct, the involvement information being indicative of an involvement between the accessor and a third party (at 404) may include receiving an involvement information using a Flash application at 421 (e.g. a Flash application that provides animation or other enhanced interactive capabilities and that monitors or reports web browser activities). Similarly, in some implementations, receiving an involvement information using a machine-implemented Web 2.0 construct, the involvement information being indicative of an involvement between the accessor and a third party (at 404) may include receiving an involvement information using a mashup that includes at least one Flash application at 423 (e.g. a mashup that provides audio or visual content to a viewer and a Flash application that provides animation or other enhanced interactive capabilities and that monitors or reports web browser activities).

In further implementations, receiving an involvement information using a machine-implemented Web 2.0 construct, the involvement information being indicative of an involvement between the accessor and a third party (at 404) may include receiving an involvement information using a mashup that include the electronic accessed content and at least one of a web service, an Ajax application, a Flash application, an electronic content, or another electronic accessed content at 425 (e.g. a mashup that includes a product review and an engine that monitors or reports web browser activities). Similarly, in some implementations, receiving an involvement information using a machine-implemented Web 2.0 construct, the involvement information being indicative of an involvement between the accessor and a third party (at 404) may include receiving an involvement information using an open source machine-implemented Web 2.0 construct at 427 (e.g. an open-source engine that monitors or reports web browser activities, or an open-source application that documents access time durations). In further implementations, receiving an involvement information using a machine-implemented Web 2.0 construct, the involvement information being indicative of an involvement between the accessor and a third party (at 404) may include receiving an involvement information using a user-community modifiable machine-implemented Web 2.0 construct at 429 (e.g. a user-community modifiable construct that monitors or reports downloading or browsing activities and time durations).

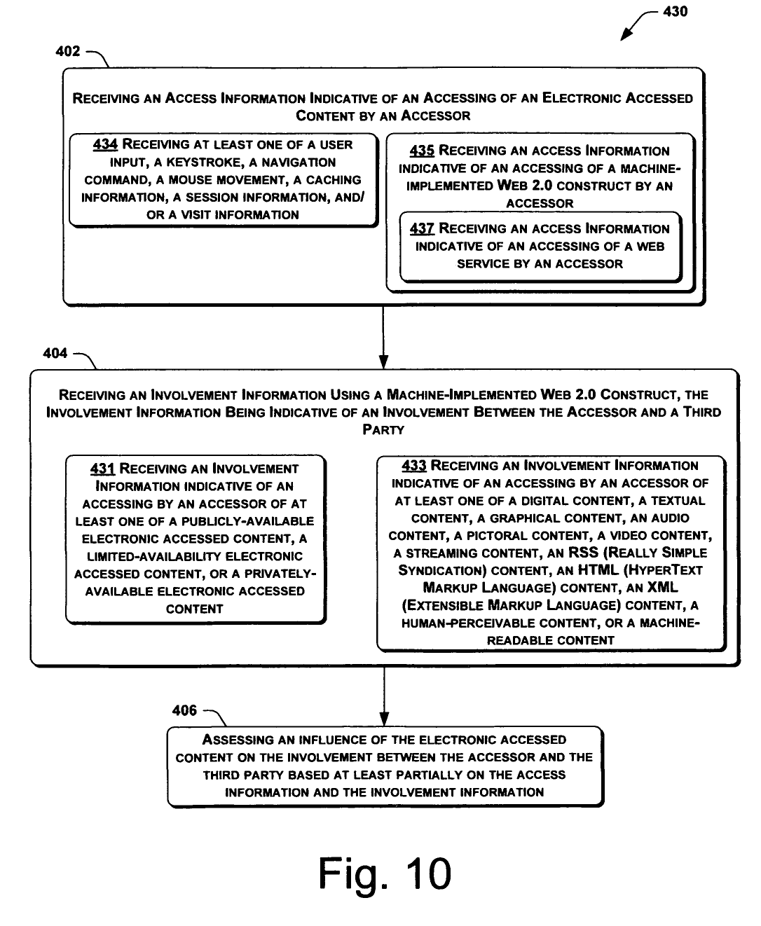

In some implementations, such as a process 430 shown in FIG. 10, receiving an involvement information using a machine-implemented Web 2.0 construct, the involvement information being indicative of an involvement between the accessor and a third party (at 404) may include receiving an access information indicative of an accessing by an accessor of at least one of a publicly-available electronic accessed content, a limited-availability electronic accessed content, or a privately-available electronic accessed content at 431. For example, the receiving of the access information (at 404) may include receiving an email message documenting a patron's accessing history of a publicly-available electronic library, a limited-availability electronic library (e.g. available only to registered patrons or pay-per-view patrons), or a privately-available electronic library (e.g. a library owned by a club or corporation).

Similarly, in some implementations, receiving an involvement information using a machine-implemented Web 2.0 construct, the involvement information being indicative of an involvement between the accessor and a third party (at 404) may include receiving an access information indicative of an accessing by an accessor of at least one of a digital content, a textual content, a graphical content, an audio content, a pictoral content, a video content, a streaming content, an RSS (Really Simple Syndication) content, an HTML (HyperText Markup Language) content, an XML (Extensible Markup Language) content, a human-perceivable content, or a machine-readable content at 433 (e.g. receiving electronic signals indicating a user's accessing of graphical content from a news-related service).

As further shown in FIG. 10, in some implementations, receiving an access information indicative of an accessing of an electronic accessed content by an accessor (at 402) may include receiving at least one of a user input, a keystroke, a navigation command, a mouse movement, a caching information, a session information, and/or a visit information at 434. For example, the at least one of a user input, a keystroke, a navigation command, a mouse movement, a caching information, a session information, and/or a visit information may include information associated with, incidental to, and/or responsive to one or more of user mouse movements, scrolling movements, purchases, operations, visited Websites, visited blogs, page views, page visits, viewing time, repeat visits, page tags, printing a content, click stream, search strings, local search strings, interactions, scrolling, menu activity, corresponding/related to browsing the Internet, cut and past, print history, browsing history, email, cookies, user keystrokes, logged keystrokes along with the window name they are typed, email sent, email received, logged events, logged timeline, Website activity, logged Websites visited, application usage; log of applications run, documents opened, saved documents, files opened, files viewed, cut, cut and paste, scrolling, navigating, and setting a bookmark. In further implementations, the access information may include data indicative of a computing system environment, a local computing system interaction associated with the client-side computing device, a network interaction including bulk content downloaded to form a page, a turning of visibility tags on and off, and/or an interactive environment.

In further implementations, receiving an access information indicative of an accessing of an electronic accessed content by an accessor (at 402) may include receiving an access information indicative of an accessing of a machine-implemented Web 2.0 construct by an accessor at 435 (e.g. receiving information indicating a user's viewing of visual content from a mashup that includes a Web-based information service). More specifically, in some implementations, receiving an access information indicative of an accessing of a machine-implemented Web 2.0 construct by an accessor (at 435) may include receiving an access information indicative of an accessing of a web service by an accessor at 437 (e.g. receiving information indicating a user's viewing of visual content from a Web-based information service).

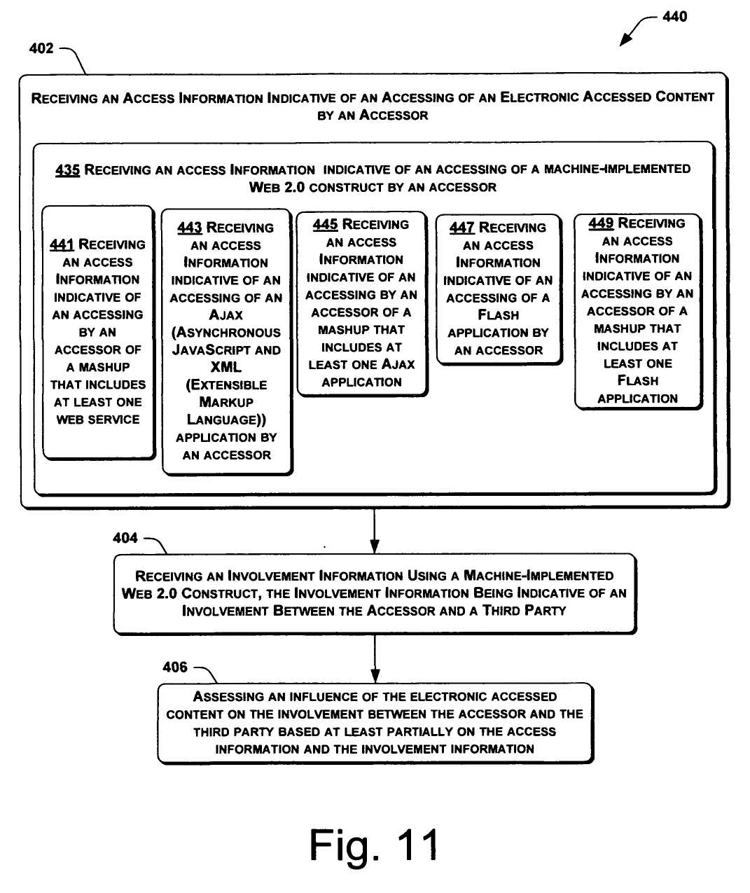

As depicted in a process 440 shown in FIG. 11, in some implementations, receiving an access information indicative of an accessing of a machine-implemented Web 2.0 construct by an accessor (at 435) may include receiving an access information indicative of an accessing by an accessor of a mashup that includes at least one web service at 441 (e.g. receiving information indicating a mobile device's downloading of audio content from a mashup that includes an RSS service). In further implementations, receiving an access information indicative of an accessing of a machine-implemented Web 2.0 construct by an accessor (at 435) may include receiving an access information indicative of an accessing of an Ajax (Asynchronous JavaScript and XML (Extensible Markup Language)) application by an accessor at 443 (e.g. receiving information indicating a PDA (Personal Data Assistant) access of an Ajax application from a website that provides Internet search services). Similarly, receiving an access information indicative of an accessing of a machine-implemented Web 2.0 construct by an accessor (at 435) may include receiving an access information indicative of an accessing by an accessor of a mashup that includes at least one Ajax application at 445 (e.g. receiving information indicating a PDA (Personal Data Assistant) access of a mashup that includes an Ajax application from a website that provides Internet search services).

As further shown in FIG. 11, in some implementations, receiving an access information indicative of an accessing of a machine-implemented Web 2.0 construct by an accessor (at 435) may include receiving an access information indicative of an accessing of a Flash application by an accessor at 447 (e.g. receiving information indicating a computer access of an animation-related Flash application from a website that offers books or other printed materials for sale). In further implementations, receiving an access information indicative of an accessing of a machine-implemented Web 2.0 construct by an accessor (at 435) may include receiving an access information indicative of an accessing by an accessor of a mashup that includes at least one Flash application at 449 (e.g. receiving information indicating a computer access of a mashup that includes an animation-related Flash application from a website that offers services for sale).

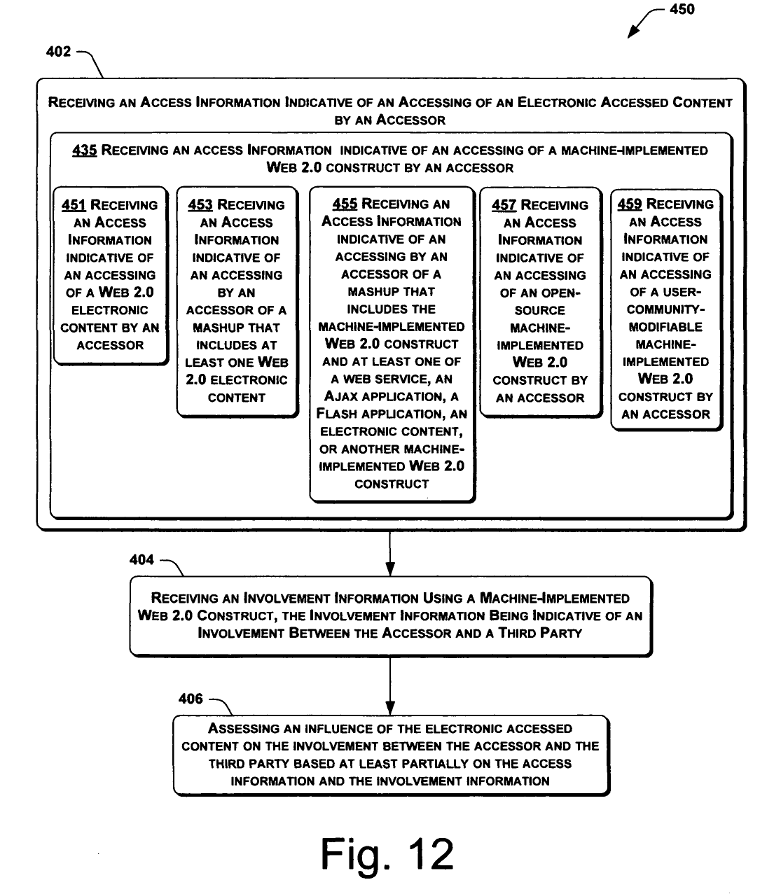

In some implementations, such as a process 450 shown in FIG. 12, receiving an access information indicative of an accessing of a machine-implemented Web 2.0 construct by an accessor (at 435) may include receiving an access information indicative of an accessing of a Web 2.0 electronic content by an accessor at 451 (e.g. receiving a report indicating an accessing of an electronic article by a potential consumer). In further implementations, receiving an access information indicative of an accessing of a machine-implemented Web 2.0 construct by an accessor (at 435) may include receiving an access information indicative of an accessing by an accessor of a mashup that includes at least one Web 2.0 electronic content at 453 (e.g. receiving a report indicating an accessing by a potential consumer of a mashup from a provider of advertising that includes an electronic article). Similarly, receiving an access information indicative of an accessing of a machine-implemented Web 2.0 construct by an accessor (at 435) may include receiving an access information indicative of an accessing by an accessor of a mashup that includes the machine-implemented Web 2.0 construct and at least one of a web service, an Ajax application, a Flash application, an electronic content, or another machine-implemented Web 2.0 construct at 455 (e.g. receiving documentation indicating an accessing by a potential consumer of a mashup from a provider of advertising that includes an Ajax application and a web service that facilitates an RIA (Rich Internet Application)).

As further shown in FIG. 12, receiving an access information indicative of an accessing of a machine-implemented Web 2.0 construct by an accessor (at 435) may include receiving an access information indicative of an accessing of an open-source machine-implemented Web 2.0 construct by an accessor at 457 (e.g. receiving information indicating an accessing by a browser of an open-source Ajax application). In still other implementations, receiving an access information indicative of an accessing of a machine-implemented Web 2.0 construct by an accessor (at 435) may include receiving an access information indicative of an accessing of a user-community-modifiable machine-implemented Web 2.0 construct by an accessor at 459 (e.g. receiving information indicating an accessing by a device of a user-community-modifiable asynchronous interface engine).

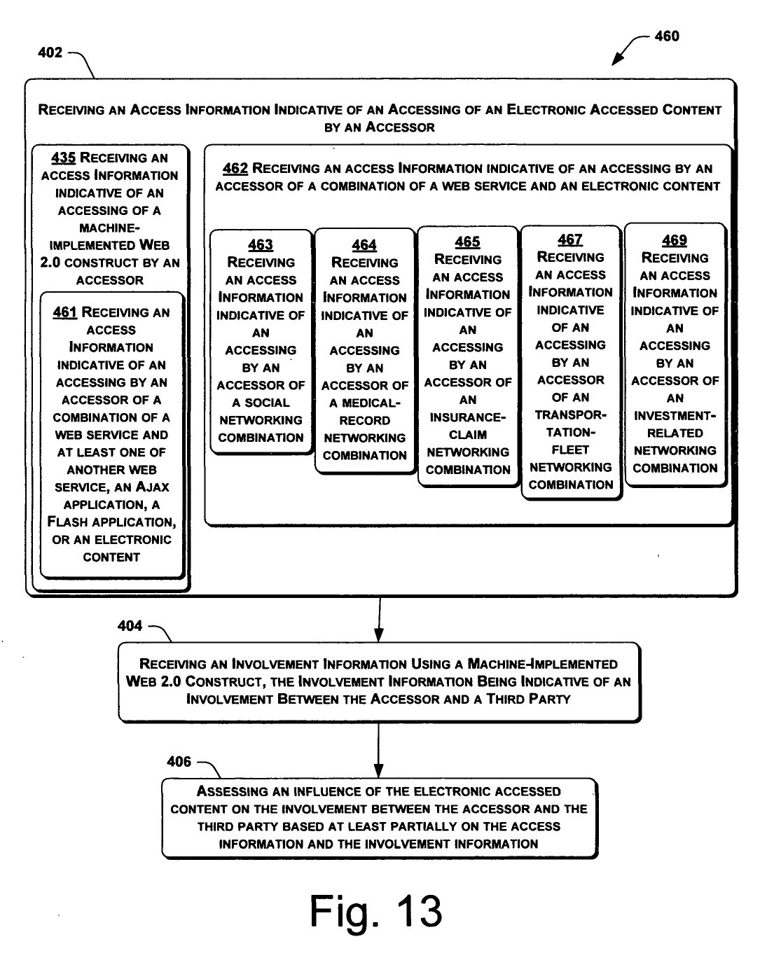

With reference now to FIG. 13, in a process 460, receiving an access information indicative of an accessing of a machine-implemented Web 2.0 construct by an accessor (at 435) may include receiving an access information indicative of an accessing by an accessor of a combination of a web service and at least one of another web service, an Ajax application, a Flash application, or an electronic content at 461 (e.g. receiving information indicating an accessing by a potential consumer of a combination of a Flash application that shows animation of a product in operation). Similarly, in some implementations, receiving an access information indicative of an accessing of a machine-implemented Web 2.0 construct by an accessor (at 435) may include receiving an access information indicative of an accessing by an accessor of a combination of a web service and an electronic content at 462 (e.g. receiving information indicating an accessing by a potential consumer of a combination of a consumer-advocacy service and an article regarding particular products or services).

It will be appreciated that receiving an access information indicative of an accessing by an accessor of a combination of a web service and an electronic content (at 462) may include numerous particular implementations. For example, as further shown in FIG. 13, in some implementations, receiving an access information indicative of an accessing by an accessor of a combination of a web service and an electronic content (at 462) may include receiving an access information indicative of an accessing by an accessor of a social networking combination at 463 (e.g. receiving information indicating an accessing by an individual of an Ajax application in combination with content related to potential dating partners). Similarly, in some implementations, receiving an access information indicative of an accessing by an accessor of a combination of a web service and an electronic content (at 462) may include receiving an access information indicative of an accessing by an accessor of a medical-record networking combination at 464 (e.g. receiving information indicating an accessing by an nurse of an asynchronous engine in combination with electronic information relating to patient medical history).

In further implementations, receiving an access information indicative of an accessing by an accessor of a combination of a web service and an electronic content (at 462) may include receiving an access information indicative of an accessing by an accessor of an insurance-claim networking combination at 465 (e.g. receiving information indicating an accessing by a claims adjustor of an application in combination with electronic information relating to vehicle repairs). Similarly, receiving an access information indicative of an accessing by an accessor of a combination of a web service and an electronic content (at 462) may include receiving an access information indicative of an accessing by an accessor of a transportation-fleet networking combination at 467 (e.g. receiving information indicating an accessing by a planner of an application in combination with electronic information relating to aircraft availability). In further implementations, receiving an access information indicative of an accessing by an accessor of a combination of a web service and an electronic content (at 462) may include receiving an access information indicative of an accessing by an accessor of an investment-related networking combination at 469 (e.g. receiving information indicating an accessing by a broker of a web service in combination with electronic information relating to stock prices).

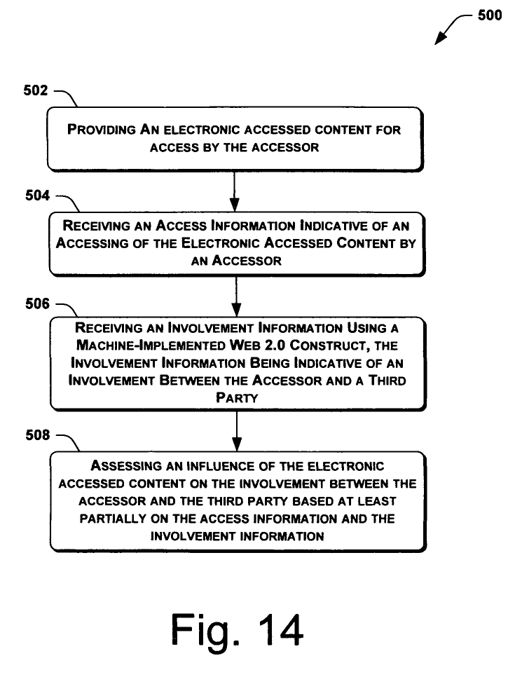

FIG. 14 is a flowchart of method 500 in accordance with another implementation of the present disclosure. In this implementation, the method 500 includes providing the electronic accessed content for access by the accessor at 502 (e.g. operating a server that hosts the electronic accessed content, or offering a web service, or providing access to an electronic library), receiving an access information indicative of an accessing of an electronic accessed content by an accessor at 504 (e.g. receiving data packets indicating an accessing of the electronic accessed content), receiving an involvement information using a machine-implemented Web 2.0 construct, the involvement information being indicative of an involvement between the accessor and a third party at 506 (e.g. receiving information signals via a mashup that includes an Ajax application), and assessing an influence of the electronic accessed content on the involvement between the accessor and the third party based at least partially on the access information and the involvement information at 508 (e.g. assessing an influence of the electronic accessed content on a purchase-and-sale transaction between and consumer and a vendor).

In some implementations, the providing the electronic accessed content for access by the accessor at 502 may be performed by the same entity that performs the receiving an involvement information using a machine-implemented Web 2.0 construct, the involvement information being indicative of an involvement between the accessor and a third party at 506. For example, in some implementations, an entity that provides the electronic accessed content for access by the accessor and that receives involvement information using a machine-implemented Web 2.0 construct may include an online retailer, an online search provider, an information broker, an advertiser, a web service provider, or any other suitable entity.

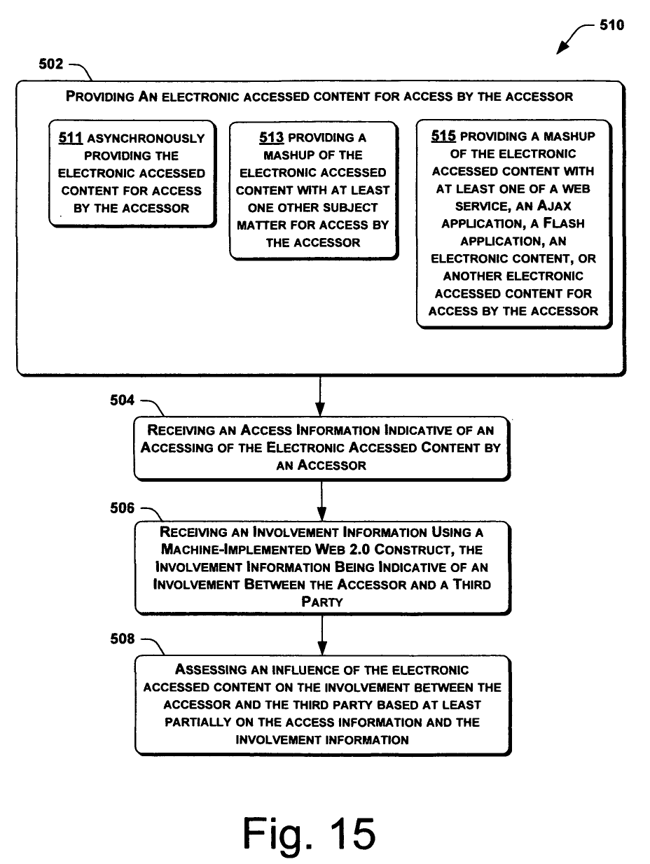

It will be appreciated that providing the electronic accessed content for access by the accessor at 502 may be accomplished in a variety of ways. For example, in a method 510 as shown in FIG. 15, providing the electronic accessed content for access by the accessor (at 502) includes asynchronously providing the electronic accessed content for access by the accessor at 511 (e.g. providing the electronic accessed content using an asynchronous engine). Similarly, in some implementations, providing the electronic accessed content for access by the accessor (at 502) may include providing a mashup of the electronic accessed content with at least one other subject matter for access by the accessor at 513 (e.g. providing a technical brochure mashed up with an HTML article). In further implementations, providing the electronic accessed content for access by the accessor (at 502) may include providing a mashup of the electronic accessed content with at least one of a web service, an Ajax application, a Flash application, an electronic content, or another electronic accessed content for access by the accessor at 515 (e.g. providing a technical brochure mashed up with an RSS service).

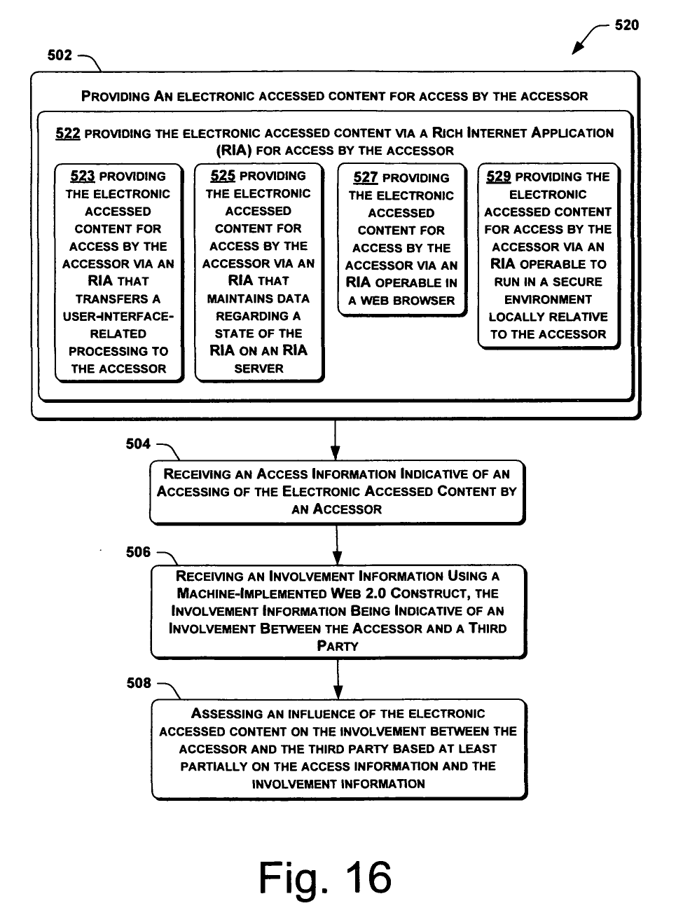

In further implementations, such as a process 520 shown in FIG. 16, providing the electronic accessed content for access by the accessor (at 502) may include providing the electronic accessed content via a Rich Internet Application (RIA) for access by the accessor at 522 (e.g. providing an editorial content using an interactive Flash application). More specifically, in some implementations, providing the electronic accessed content via a Rich Internet Application (RIA) for access by the accessor (at 522) may include providing the electronic accessed content for access by the accessor via an RIA that transfers a user-interface-related processing to the accessor at 523 (e.g. providing an editorial content using an interactive Flash application loaded onto a viewer's device that handles interface-related processing). Similarly, in some implementations, providing the electronic accessed content via a Rich Internet Application (RIA) for access by the accessor (at 522) may include providing the electronic accessed content for access by the accessor via an RIA that maintains data regarding a state of the RIA on an RIA server at 525 (e.g. providing an editorial content using an interactive Flash application on a server that hosts the Flash application and maintains state data thereon).

In further implementations, providing the electronic accessed content via a Rich Internet Application (RIA) for access by the accessor (at 522) may include providing the electronic accessed content for access by the accessor via an RIA operable in a web browser at 527 (e.g. providing an editorial content using an interactive Flash application operable in Microsoft's Internet Explorer®). Similarly, in some implementations, providing the electronic accessed content via a Rich Internet Application (RIA) for access by the accessor (at 522) may include providing the electronic accessed content for access by the accessor via an RIA operable to run in a secure environment locally relative to the accessor at 529 (e.g. providing an editorial content using a Mocha application operable in to run in a “sandbox” environment on a mobile device).

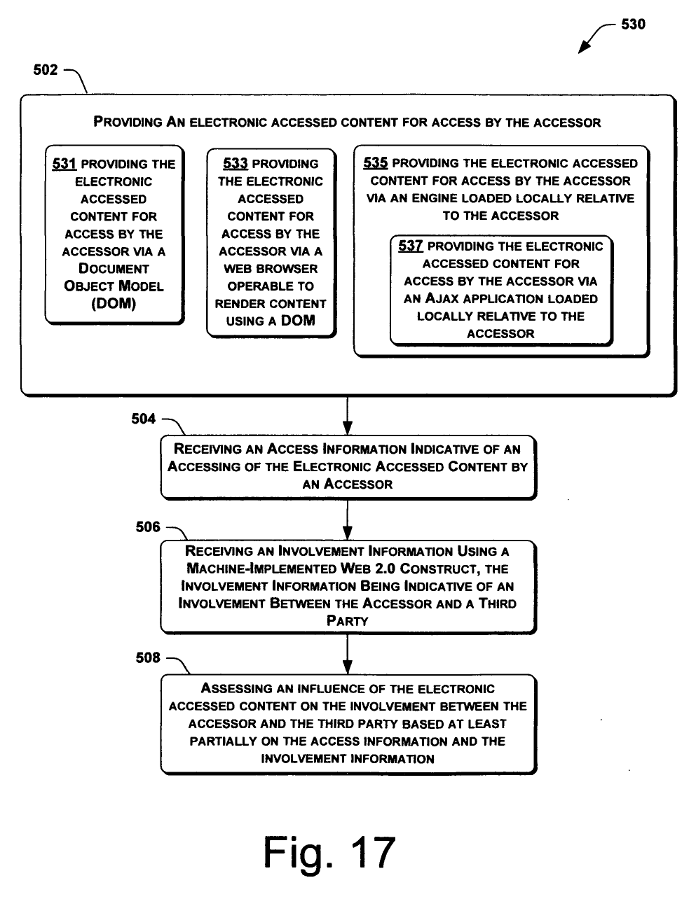

As shown in FIG. 17, in further implementations (e.g. process 530), providing the electronic accessed content for access by the accessor (at 502) may include may include providing the electronic accessed content for access by the accessor via a Document Object Model (DOM) at 531 (e.g. providing an audio packet using a DOM-based Ajax application). In other implementations, providing the electronic accessed content for access by the accessor (at 502) may include providing the electronic accessed content for access by the accessor via a web browser operable to render content using a DOM at 533 (e.g. providing a video stream using a DOM-renderable version of Google's Chrome® browser).

Similarly, in some implementations, providing the electronic accessed content for access by the accessor (at 502) may include providing the electronic accessed content for access by the accessor via an engine loaded locally relative to the accessor at 535 (e.g. providing an mpeg file using an asynchronous engine loaded on a viewer's mobile device). More specifically, in particular implementations, providing the electronic accessed content for access by the accessor via an engine loaded locally relative to the accessor (at 535) may include providing the electronic accessed content for access by the accessor via an Ajax application loaded locally relative to the accessor at 537 (e.g. providing an mpeg file using an Ajax-based engine loaded on a viewer's mobile device).

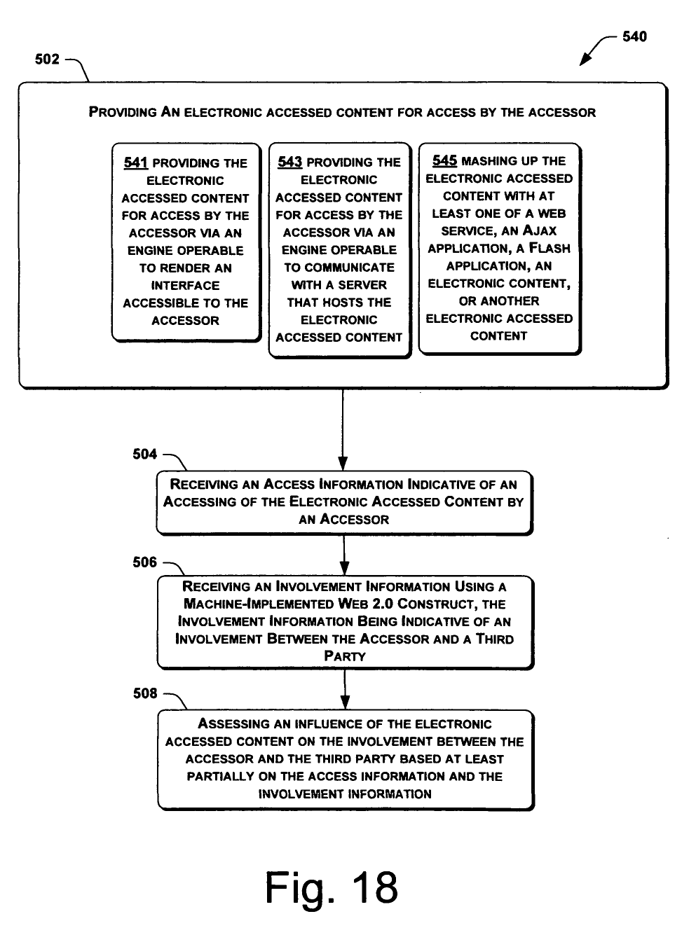

As shown in FIG. 18, in further implementations (e.g. a process 540), providing the electronic accessed content for access by the accessor (at 502) may include providing the electronic accessed content for access by the accessor via an engine operable to render an interface accessible to the accessor at 541 (e.g. providing an electronic communication using an application that performs menu-related functions). Similarly, providing the electronic accessed content for access by the accessor (at 502) may include providing the electronic accessed content for access by the accessor via an engine operable to communicate with a server that hosts the electronic accessed content at 543 (e.g. providing an electronic communication using an application that performs content-fetching functions). In other implementations, providing the electronic accessed content for access by the accessor (at 502) may include mashing up the electronic accessed content with at least one of a web service, an Ajax application, a Flash application, an electronic content, or another electronic accessed content at 545 (e.g. mashing up an electronic communication with an advertising service).

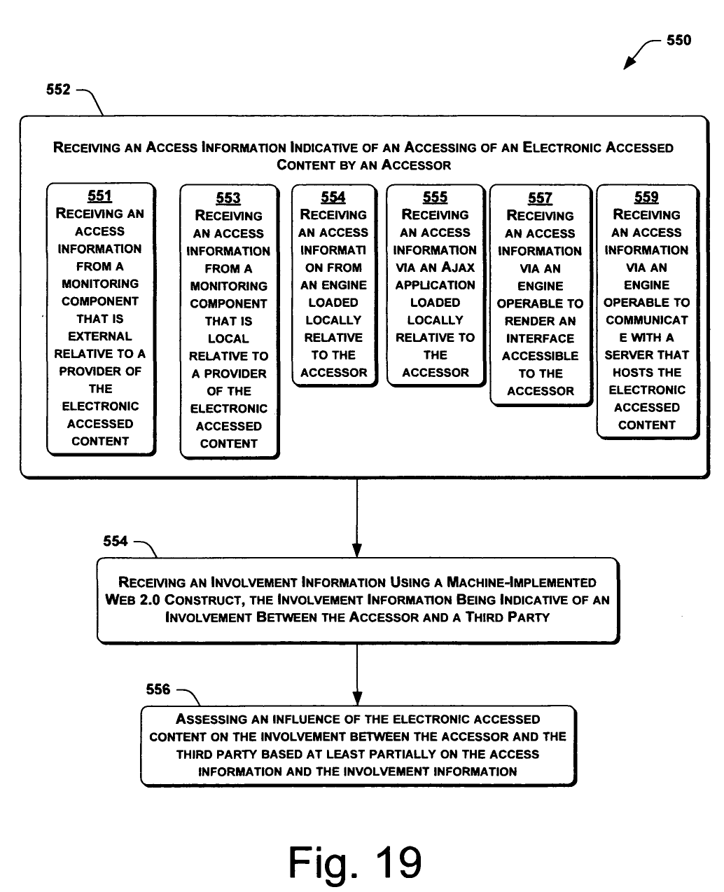

In still other implementations, such as process 550 shown in FIG. 19, receiving an access information indicative of an accessing of an electronic accessed content by an accessor (at 502) may include receiving an access information from a monitoring component that is external relative to a provider of the electronic accessed content at 551 (e.g. receiving a signal from a tracking cookie installed on the accessor's device). Similarly, receiving an access information indicative of an accessing of an electronic accessed content by an accessor (at 502) receiving an access information from a monitoring component that is local relative to a provider of the electronic accessed content at 553 (e.g. receiving a signal from an inwardly-looking application installed on a server that hosts the electronic accessed content).

In further implementations, providing the electronic accessed content for access by the accessor (at 502) may include receiving an access information from an engine loaded locally relative to the accessor at 554 (e.g. receiving data from an Applet installed on a laptop of the accessor). In addition, providing the electronic accessed content for access by the accessor (at 502) may include receiving an access information via an Ajax application loaded locally relative to the accessor at 555 (e.g. receiving data from an Ajax application installed on a computing device of the accessor). Similarly, providing the electronic accessed content for access by the accessor (at 502) may include receiving an access information via an engine operable to render an interface accessible to the accessor at 557 (e.g. receiving information from an interface-rendering Ajax application installed on a computing device of the accessor). In still other implementations, providing the electronic accessed content for access by the accessor (at 502) may include receiving an access information via an engine operable to communicate with a server that hosts the electronic accessed content at 559 (e.g. receiving information from a content-rendering Applet installed on a computing device of the accessor).

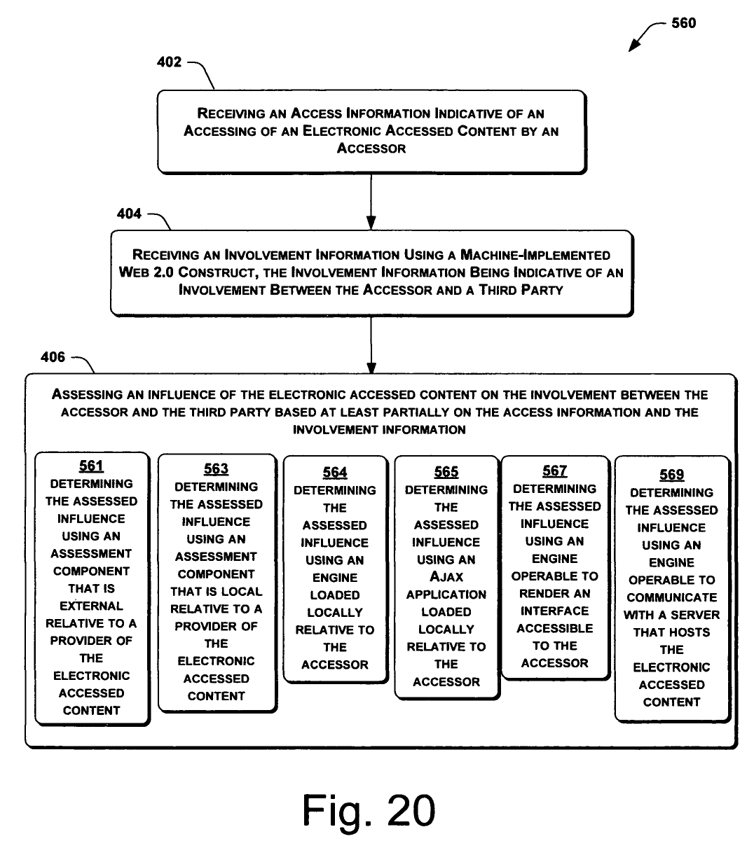

Referring now to FIG. 20, it may be noted that assessing an influence of the electronic accessed content on the involvement between the accessor and the third party based at least partially on the access information and the involvement information (at 406) may be performed in a variety of suitable ways. For example, in some implementation, such as a process 560, assessing an influence of the electronic accessed content on the involvement between the accessor and the third party based at least partially on the access information and the involvement information (at 406) may include determining the assessed influence using an assessment component that is external relative to a provider of the electronic accessed content at 561 (e.g. determining the assessed influence using software operated by a third party on a third-party computing device). Similarly, in some implementations, assessing an influence of the electronic accessed content on the involvement between the accessor and the third party based at least partially on the access information and the involvement information (at 406) may include determining the assessed influence using an assessment component that is local relative to a provider of the electronic accessed content at 563 (e.g. determining the assessed influence using software operating on the computing device of the accessor).

In still other implementations, assessing an influence of the electronic accessed content on the involvement between the accessor and the third party based at least partially on the access information and the involvement information (at 406) may include determining the assessed influence using an engine loaded locally relative to the accessor at 564 (e.g. determining the assessed influence using an asynchronously-operating application operating on a mobile device of the accessor). Similarly, assessing an influence of the electronic accessed content on the involvement between the accessor and the third party based at least partially on the access information and the involvement information (at 406) may include determining the assessed influence using an Ajax application loaded locally relative to the accessor at 565 (e.g. determining the assessed influence using an Ajax application operating on a mobile device of the accessor). In further implementations, assessing an influence of the electronic accessed content on the involvement between the accessor and the third party based at least partially on the access information and the involvement information (at 406) may include determining the assessed influence using an engine operable to render an interface accessible to the accessor at 567 (e.g. determining the assessed influence using an interface-rendering Applet). And in still other implementations, assessing an influence of the electronic accessed content on the involvement between the accessor and the third party based at least partially on the access information and the involvement information (at 406) may include determining the assessed influence using an engine operable to communicate with a server that hosts the electronic accessed content at 569 (e.g. determining the assessed influence using a content-fetching Applet).

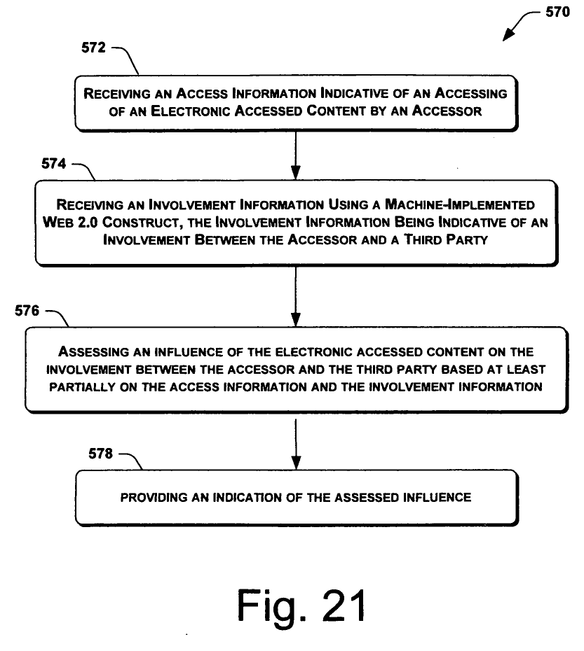

FIG. 21 is a flowchart of method 570 in accordance with another implementation of the present disclosure. In this implementation, the method 570 includes receiving an access information indicative of an accessing of an electronic accessed content by an accessor at 572 (e.g. receiving data indicating a period of access of a movie-review article by a potential movie-goer), receiving an involvement information using a machine-implemented Web 2.0 construct, the involvement information being indicative of an involvement between the accessor and a third party at 574 (e.g. receiving ticket-purchase information via a web service regarding the movie-goer's purchase of a ticket from a theater), assessing an influence of the electronic accessed content on the involvement between the accessor and the third party based at least partially on the access information and the involvement information at 576 (e.g. assigning an influence level of the movie-review article to the movie-goer's ticket purchase), and providing an indication of the assessed influence at 578 (e.g. notifying the theater of the influence level of the movie-review article).

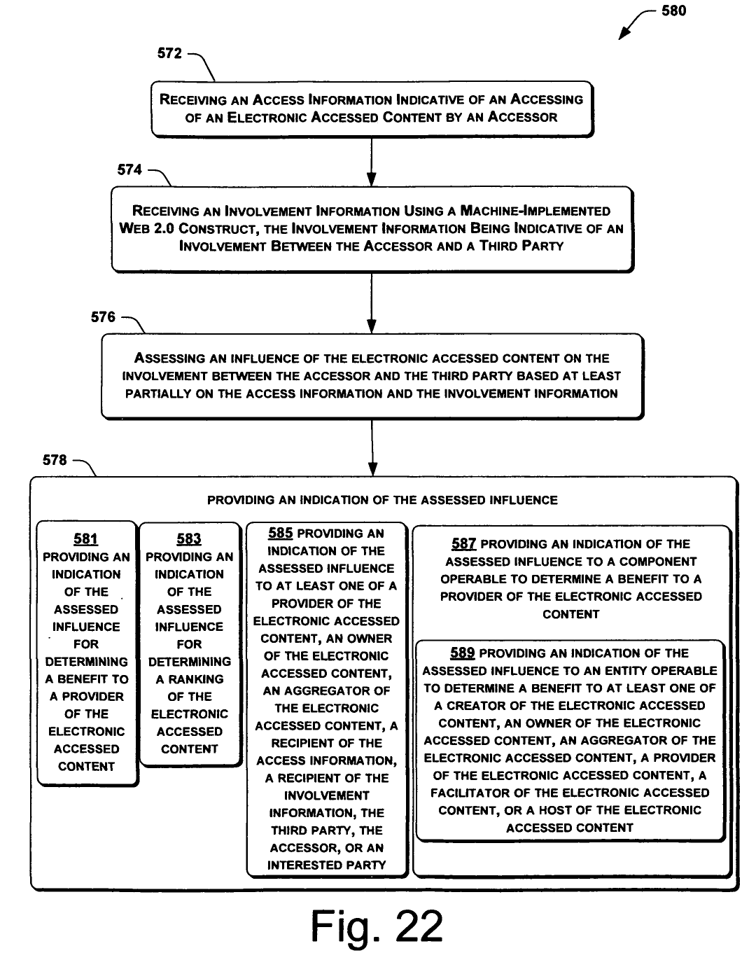

It will be appreciated that providing an indication of the assessed influence at 578 may be accomplished in a variety of ways. For example, in a process 580 shown in FIG. 22, providing an indication of the assessed influence (at 578) may include providing an indication of the assessed influence for determining a benefit to a provider of the electronic accessed content at 581 (e.g. notifying the theater of the influence level from which the theater may decide to provide free passes to an author of the movie-review article). In some implementations, providing an indication of the assessed influence (at 578) may include providing an indication of the assessed influence for determining a ranking of the electronic accessed content at 583 (e.g. notifying the theater of the influence level from which the theater may decide whether to cite the movie-review article in a future press release). Similarly, providing an indication of the assessed influence (at 578) may include providing an indication of the assessed influence to at least one of a provider of the electronic accessed content, an owner of the electronic accessed content, an aggregator of the electronic accessed content, a recipient of the access information, a recipient of the involvement information, the third party, the accessor, or an interested party at 585 (e.g. notifying an electronic news-provider of the influence level of the movie-review article).

As further shown in FIG. 22, in some implementations, providing an indication of the assessed influence (at 578) includes providing an indication of the assessed influence to a component operable to determine a benefit to a provider of the electronic accessed content at 587 (e.g. notifying a software application of the influence level from which the software application may decide to provide free passes to an author of the movie-review article). It will be appreciated that providing an indication of the assessed influence to a component operable to determine a benefit to a provider of the electronic accessed content at 587 may be accomplished in a variety of suitable ways. For example, in some implementations, providing an indication of the assessed influence to a component operable to determine a benefit to a provider of the electronic accessed content (at 587) may include providing an indication of the assessed influence to an entity operable to determine a benefit to at least one of a creator of the electronic accessed content, an owner of the electronic accessed content, an aggregator of the electronic accessed content, a provider of the electronic accessed content, a facilitator of the electronic accessed content, or a host of the electronic accessed content at 589 (e.g. notifying a software application of the influence level from which the software application may decide to provide free passes to an electronic-news service that provided the movie-review article).

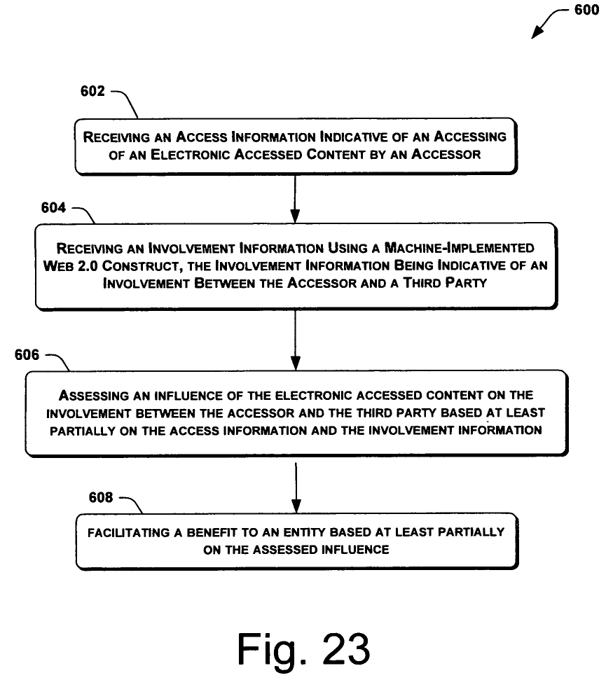

FIG. 23 is a flowchart of method 600 in accordance with another implementation of the present disclosure. In this implementation, the method 600 includes receiving an access information indicative of an accessing of an electronic accessed content by an accessor at 602 (e.g. receiving information indicating that an electronic news article was scanned by a webcrawler program), receiving an involvement information using a machine-implemented Web 2.0 construct, the involvement information being indicative of an involvement between the accessor and a third party at 604 (e.g. receiving involvement data indicative that the webcrawler program provided information regarding the news article, such as a copy of the news article, a ranking of the news article, etc., to an information broker), assessing an influence of the electronic accessed content on the involvement between the accessor and the third party based at least partially on the access information and the involvement information at 606 (e.g. assessing an influence of the news article on the involvement between the webcrawler and the information broker, based on, for example, the webcrawler's ranking of the news article, or the information broker's subsequent usage of the news article, etc.), and facilitating a benefit to an entity based at least partially on the assessed influence at 608 (e.g. providing compensation to a provider of the news article based on the assessed influence).

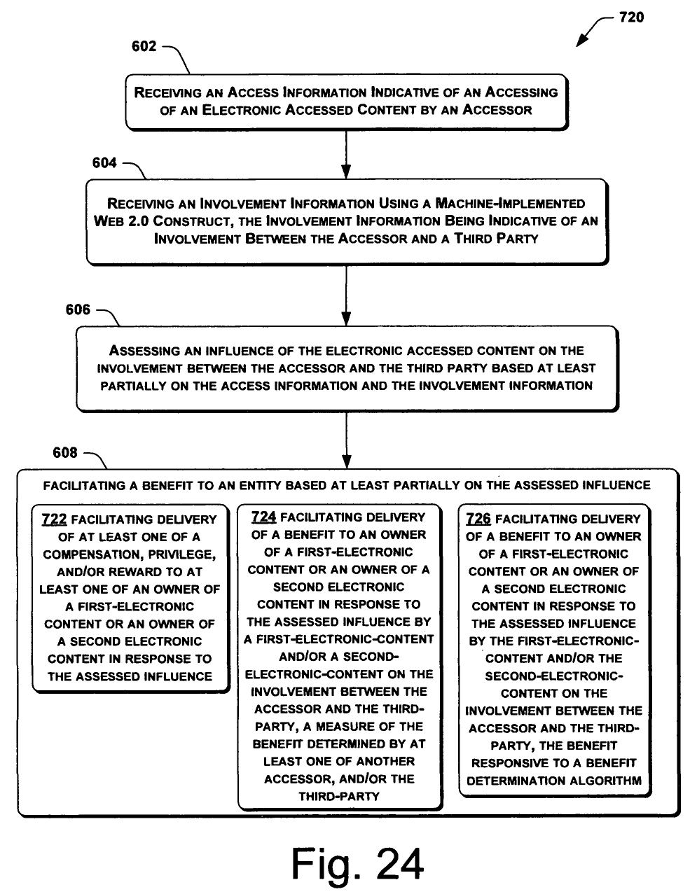

It will be appreciated that facilitating a benefit to an entity based at least partially on the assessed influence at 608 may be accomplished in a variety of ways. For example, in a process 720 shown in FIG. 24, facilitating a benefit to an entity based at least partially on the assessed influence (at 608) may include facilitating delivery of at least one of a compensation, privilege, and/or reward to at least one of an owner of a first electronic content or an owner of a second electronic content in response to the assessed influence at 722 (e.g. recommending a credit for future goods or services be provided to an owner of the first electronic content based on an assessed influence that exceeds a predetermined threshold). Similarly, facilitating a benefit to an entity based at least partially on the assessed influence (at 608) may include facilitating delivery of a benefit to an owner of a first electronic content or an owner of a second electronic content in response to the assessed influence by a first electronic-content and/or a second electronic-content on the involvement between the accessor and the third-party, a measure of the benefit determined by at least one of another accessor, and/or the third-party at 724 (e.g. offering a service provided by an information broker at a reduced rate to an owner of a news article based on an assessed influence of the news article, the information broker determining that the reduced rate is 75% of a normal rate for the service). In further implementations, facilitating a benefit to an entity based at least partially on the assessed influence (at 608) may include facilitating delivery of a benefit to an owner of a first electronic content or an owner of a second electronic content in response to the assessed influence by the first electronic content and/or the second electronic content on the involvement between the accessor and the third-party, the benefit responsive to a benefit determination algorithm at 726 (e.g. providing a discount on flights of a particular airline to an owner of a travel agency based on a weighting formula that determines the amount of flights booked by the travel agency on the particular airline in comparison with the total amount of flights booked by all travel agencies).

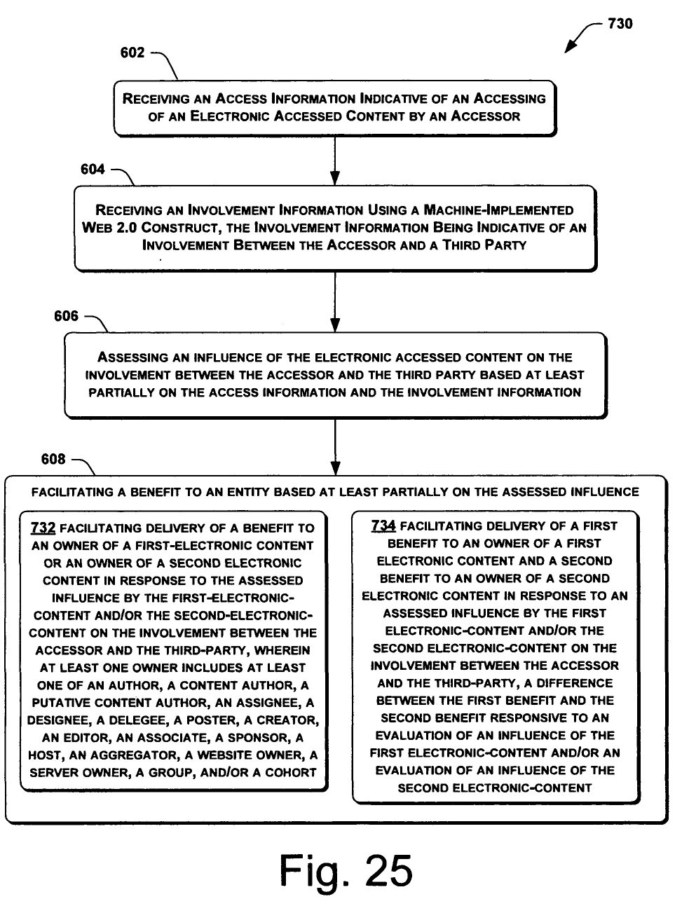

In addition, as depicted by a process 730 shown in FIG. 25, facilitating a benefit to an entity based at least partially on the assessed influence (at 608) may include facilitating delivery of a benefit to an owner of a first electronic content or an owner of a second electronic content in response to the assessed influence by the first electronic content and/or the second electronic content on the involvement between the accessor and the third-party, wherein at least one owner includes at least one of an author, a content author, a putative content author, an assignee, a designee, a delegee, a poster, a creator, an editor, an associate, a sponsor, a host, an aggregator, a website owner, a server owner, a group, and/or a cohort at 732 (e.g. transferring funds into a bank account of an organizer of a webcast event by an advertiser based on a determination that a viewer of a mashup of the webcast event and an advertisement influenced a purchase by the viewer of the advertiser's goods). In some implementations, facilitating a benefit to an entity based at least partially on the assessed influence (at 608) may include facilitating delivery of a first benefit to an owner of a first electronic content and a second benefit to an owner of a second electronic content in response to an assessed influence by the first electronic content and/or the second electronic content on the involvement between the accessor and the third-party, a difference between the first benefit and the second benefit responsive to an evaluation of an influence of the first electronic content and/or an evaluation of an influence of the second electronic content at 734 (e.g. providing a relatively smaller rate reduction on goods to a first author of a consumer report providing a moderately-positive endorsement of a product, and a relatively larger rate reduction on goods to a second author of a consumer report providing a highly-positive endorsement of the product, the difference between the larger and smaller rate reductions being based on an evaluation of the relative influence of the consumer reports by the first and second authors).

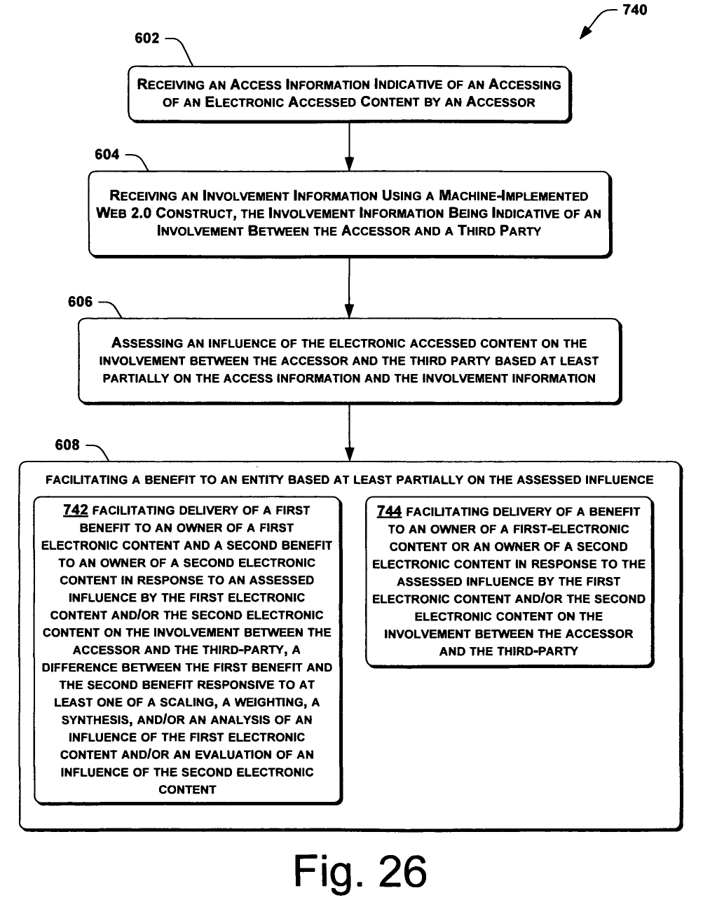

As shown in a process 740 illustrated in FIG. 26, in some implementations, facilitating a benefit to an entity based at least partially on the assessed influence (at 608) may include facilitating delivery of a first benefit to an owner of a first electronic content and a second benefit to an owner of a second electronic content in response to an assessed influence by the first electronic content and/or the second electronic content on the involvement between the accessor and the third-party, a difference between the first benefit and the second benefit responsive to at least one of a scaling, a weighting, a synthesis, and/or an analysis of an influence of the first electronic content and/or an evaluation of an influence of the second electronic content at 742 (e.g. sending first and second compensations to first and second content providers, respectively, a difference between the first and second compensations being based on relative percentages of gross sales attributable to influences by the first and second contents). Similarly, in some implementations, facilitating a benefit to an entity based at least partially on the assessed influence (at 608) may include facilitating delivery of a benefit to an owner of a first electronic content or an owner of a second electronic content in response to the assessed influence by the first electronic content and/or the second electronic content on the involvement between the accessor and the third-party at 744 (e.g. sending a percentage of profit to a provider of a map-generating service by a real estate agency that provides a mashup of real estate listings combined with the map-generating service to potential buyers based on an assessed influence of the map-generating service on actual sales of real estate to actual buyers).

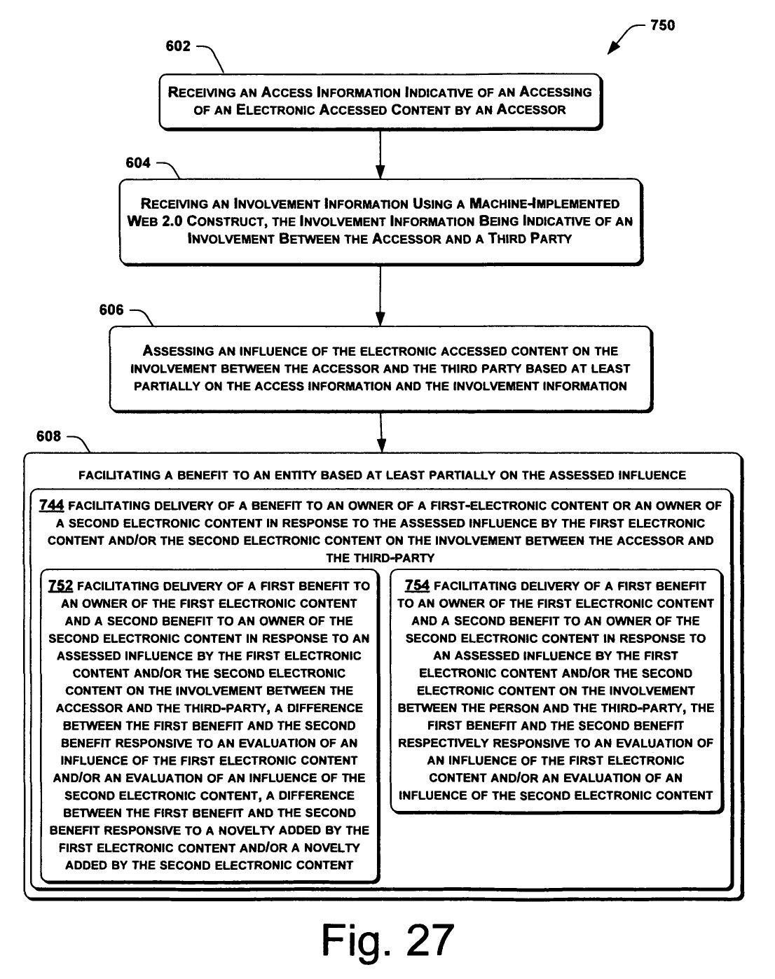

More specifically, as illustrated by a process 750 shown in FIG. 27, in some implementations, facilitating delivery of a benefit to an owner of a first electronic content or an owner of a second electronic content in response to the assessed influence by the first electronic content and/or the second electronic content on the involvement between the accessor and the third-party (at 744) may include facilitating delivery of a first benefit to an owner of the first electronic content and a second benefit to an owner of the second electronic content in response to an assessed influence by the first electronic content and/or the second electronic content on the involvement between the accessor and the third party, a difference between the first benefit and the second benefit responsive to an evaluation of an influence of the first electronic content and/or an evaluation of an influence of the second electronic content, a difference between the first benefit and the second benefit responsive to a novelty added by the first electronic content and/or a novelty added by the second electronic content at 752 (e.g. providing first and second compensations to first and second authors of scientific content based on evaluations of the respective influences of the scientific contents provided by the first and second authors on sales of scientific equipment, the influence evaluations being responsive to relative amounts of novel contributions to a particular scientific field provided by the first and second authors, respectively). Similarly, facilitating delivery of a benefit to an owner of a first electronic content or an owner of a second electronic content in response to the assessed influence by the first electronic content and/or the second electronic content on the involvement between the accessor and the third-party (at 744) may include facilitating delivery of a first benefit to an owner of the first electronic content and a second benefit to an owner of the second electronic content in response to an assessed influence by the first electronic content and/or the second electronic content on the involvement between the person and the third-party, the first benefit and the second benefit respectively responsive to an evaluation of an influence of the first electronic content and/or an evaluation of an influence of the second electronic content at 754 (e.g. providing first and second compensations to first and second authors of astronomy-related content based on first and second evaluations of the respective influences of the astronomy-related contents provided by the first and second authors on sales of astronomy-related literature).

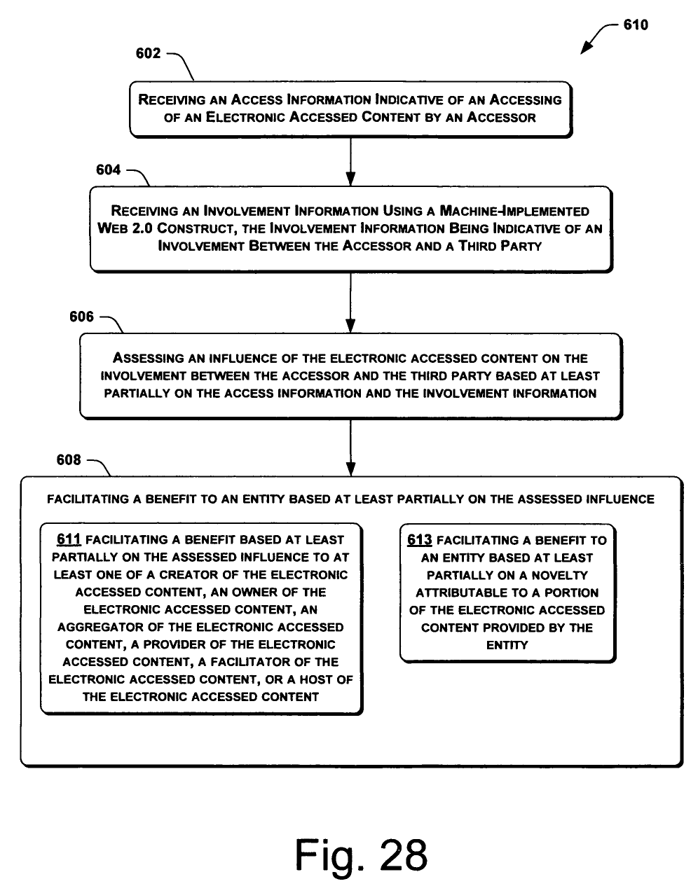

Similarly, in a process 610 shown in FIG. 28, facilitating a benefit to an entity based at least partially on the assessed influence (at 608) may include facilitating a benefit based at least partially on the assessed influence to at least one of a creator of the electronic accessed content, an owner of the electronic accessed content, an aggregator of the electronic accessed content, a provider of the electronic accessed content, a facilitator of the electronic accessed content, or a host of the electronic accessed content at 611 (e.g. providing a quantity of free web services to an online search provider that facilitates access to electronic accessed content based on an assessment of the influence of the electronic accessed content on an accessor's usage of the web service). Similarly, in some implementations, facilitating a benefit to an entity based at least partially on the assessed influence (at 608) may include facilitating a benefit to an entity based at least partially on a novelty attributable to a portion of the electronic accessed content provided by the entity at 613 (e.g. facilitating a compensation to an aggregator of movie reviews based on a novelty of the content provided by the aggregator).

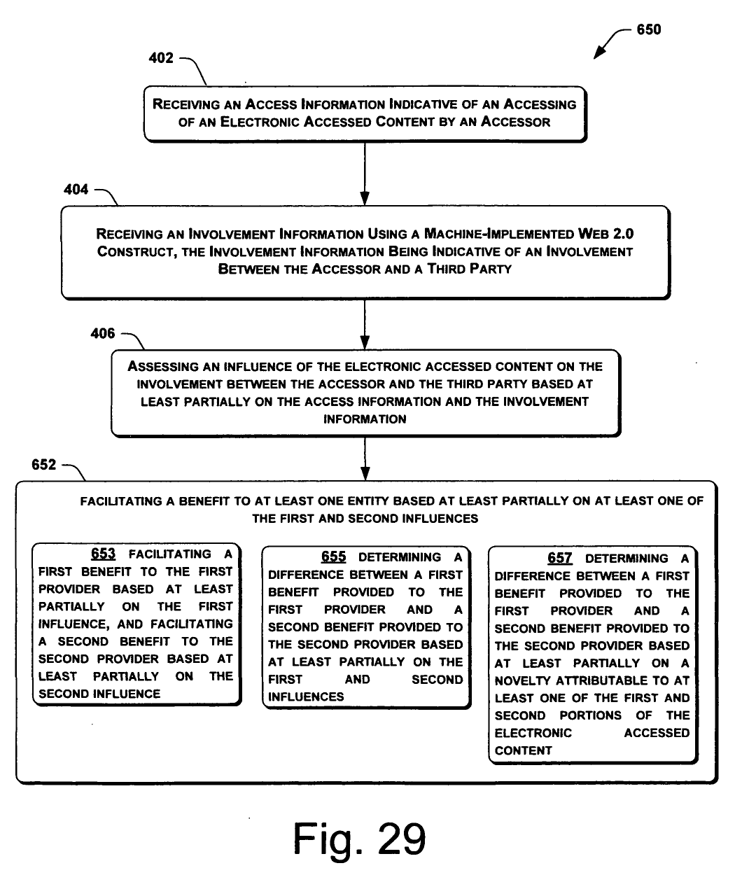

FIG. 29 is a flowchart of process 650 in accordance with another implementation of the present disclosure. In this implementation, the process 650 includes receiving an access information indicative of an accessing of an electronic accessed content by an accessor at 402 (e.g. receiving a browsing history showing a “hit” on a home improvement website by a browser), receiving an involvement information using a machine-implemented Web 2.0 construct, the involvement information being indicative of an involvement between the accessor and a third party at 404 (e.g. receiving order information indicative of an order of home improvement supplies by the browser from a supply seller), assessing an influence of the electronic accessed content on the involvement between the accessor and the third party based at least partially on the access information and the involvement information at 406 (e.g. assessing an influence of the website on the order of home improvement supplies based at least partially on the browsing history and the order information), and facilitating a benefit to at least one entity based at least partially on at least one of a first influence attributable to a first portion of the electronic accessed content and a second influence attributable to a second portion of the electronic accessed content at 652 (e.g. calculating a quantum of compensation to an owner of the website based on a first influence attributable to an advertisement portion of the website and a second influence attributable to an instructional “how-to” portion of the website).

As shown in FIG. 29, in some implementations, facilitating a benefit to at least one entity based at least partially on at least one of a first influence attributable to a first portion of the electronic accessed content and a second influence attributable to a second portion of the electronic accessed content (at 652) may include facilitating a first benefit to a first provider of a first portion of the electronic accessed content based at least partially on a first influence and facilitating a second benefit to a second provider of a second portion of the electronic accessed content based at least partially on a second influence at 653 (e.g calculating a first quantum of compensation to an advertiser based on a first influence attributable to an advertisement portion of a website and calculating a second quantum of compensation to an author based on a second influence attributable to an instructional “how-to” portion of the website). In further implementations, facilitating a benefit to at least one entity based at least partially on at least one of a first influence attributable to a first portion of the electronic accessed content and a second influence attributable to a second portion of the electronic accessed content (at 652) may include determining a difference between a first benefit provided to a first provider of a first portion of the electronic accessed content and a second benefit provided to a second provider of a second portion of the electronic accessed content based at least partially on the first and second influences at 655 (e.g. calculating a difference between a first quantum of compensation provided to an advertiser and a second quantum of compensation to an author of an instructional “how-to” portion of the website based at least partially on the first and second influences). In still other implementations, facilitating a benefit to at least one entity based at least partially on at least one of a first influence attributable to a first portion of the electronic accessed content and a second influence attributable to a second portion of the electronic accessed content (at 652) may include determining a difference between a first benefit provided to a first provider of a first portion of the electronic accessed content and a second benefit provided to a second provider of a second portion of the electronic accessed content based at least partially on a novelty attributable to at least one of the first and second portions of the electronic accessed content at 657 (e.g. calculating a difference between a first quantum of compensation provided to an advertiser and a second quantum of compensation to an author of an instructional “how-to” portion of the website based at least partially on a novelty attributable to the advertisement portion and the “how-to” portion of the website).

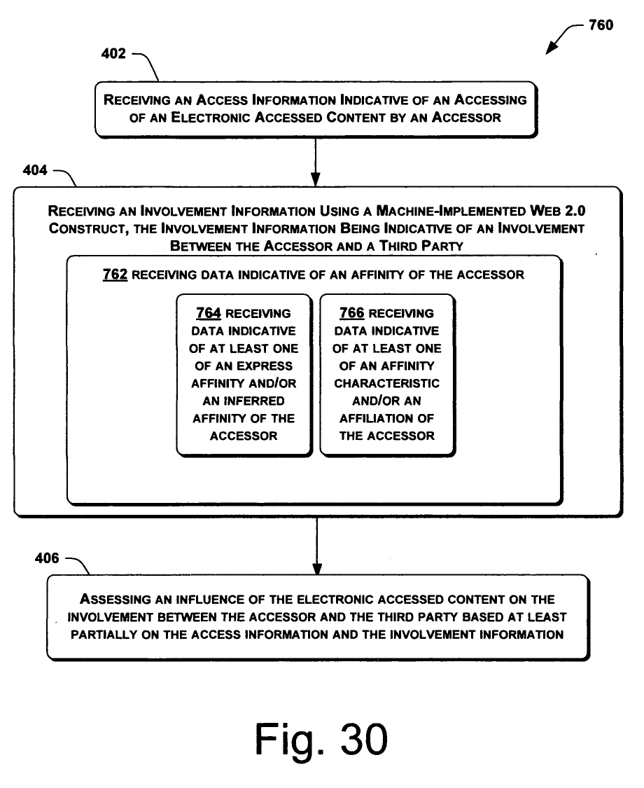

With reference to FIG. 30, in some implementations, such as a process 760, receiving an involvement information using a machine-implemented Web 2.0 construct, the involvement information being indicative of an involvement between the accessor and a third party (at 404) may include receiving data indicative of an affinity of the accessor at 762 (e.g. receiving data indicating that the accessor prefers to purchase products manufactured in the United States). More specifically, receiving data indicative of an affinity of the accessor (at 762) may include receiving data indicative of at least one of an express affinity and/or an inferred affinity of the accessor at 764 (e.g. receiving data indicative of a consumer's track record of purchasing products promoted by females over competing products promoted by males). In further implementations, receiving data indicative of an affinity of the accessor (at 762) may include receiving data indicative of at least one of an affinity characteristic and/or an affiliation of the accessor at 766 (e.g. receiving data indicative of a listener's membership on an organizing committee of the Earshot Jazz Festival in Seattle).

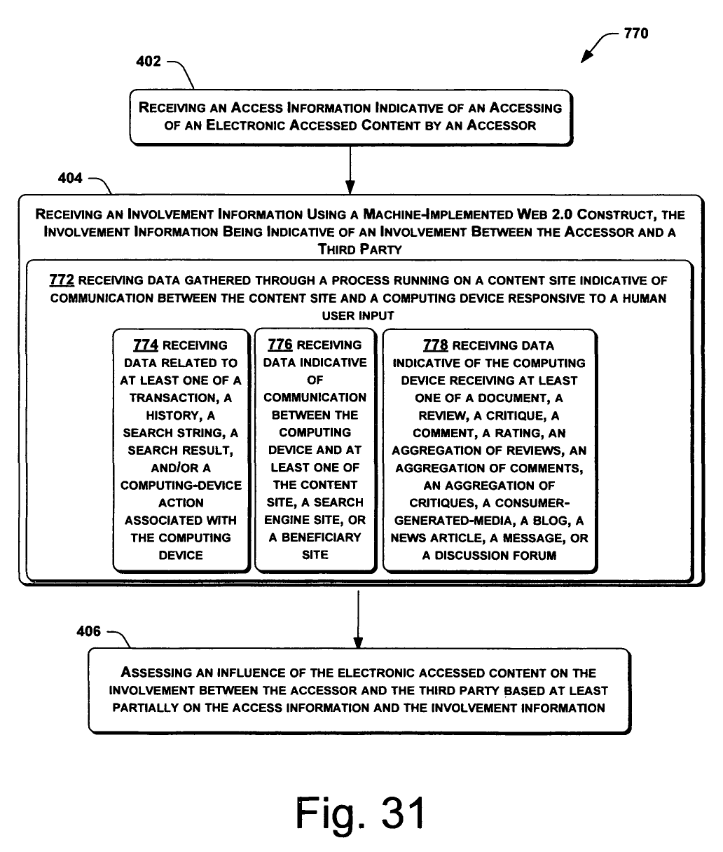

As illustrated by a process 770 shown in FIG. 31, in some implementations, receiving an involvement information using a machine-implemented Web 2.0 construct, the involvement information being indicative of an involvement between the accessor and a third party (at 404) may include receiving data gathered through a process running on a content site indicative of communication between the content site and a computing device responsive to a human user input at 772 (e.g. receiving download records from a monitoring component operating on a site that provides ringtones regarding ringtones downloaded from the site to a person's mobile communication device). More specifically, receiving data gathered through a process running on a content site indicative of communication between the content site and a computing device responsive to a human user input (at 772) may include receiving data related to at least one of a transaction, a history, a search string, a search result, and/or a computing-device action associated with the computing device at 774 (e.g. receiving records from a monitoring component operating on an online driving-directions site showing that directions were downloaded from the site to a person's mobile communication device). In some implementations, receiving data gathered through a process running on a content site indicative of communication between the content site and a computing device responsive to a human user input (at 772) may include receiving data indicative of communication between the computing device and at least one of the content site, a search engine site, or a beneficiary site at 776 (e.g. receiving records from a monitoring component operating on an online search engine site showing search strings entered on the search engine site by a person's computing device). Similarly, receiving data gathered through a process running on a content site indicative of communication between the content site and a computing device responsive to a human user input (at 772) may include receiving data indicative of the computing device receiving at least one of a document, a review, a critique, a comment, a rating, an aggregation of reviews, an aggregation of comments, an aggregation of critiques, a consumer-generated-media, a blog, a news article, a message, or a discussion forum at 778 (e.g. receiving records from a monitoring component operating on an online news site showing download histories of reviews and articles downloaded from the site to a person's personal data assistant).

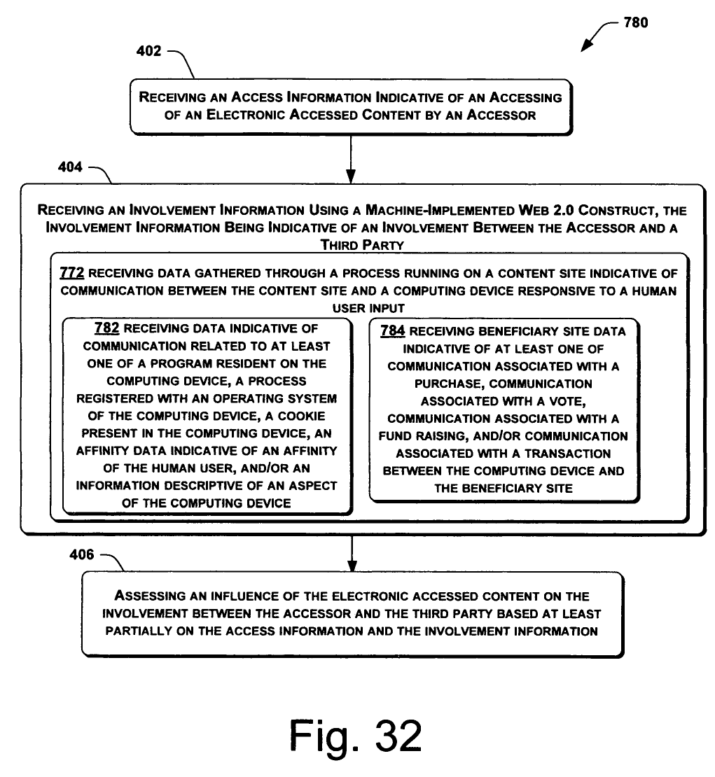

In further implementations, such as a process 780 shown in FIG. 32, receiving data gathered through a process running on a content site indicative of communication between the content site and a computing device responsive to a human user input (at 772) may include receiving data indicative of communication related to at least one of a program resident on the computing device, a process registered with an operating system of the computing device, a cookie present in the computing device, an affinity data indicative of an affinity of the human user, and/or an information descriptive of an aspect of the computing device at 782 (e.g. receiving records from a monitoring component operating on an online driving-directions site showing that directions were downloaded from the site to a navigational program residing on a person's mobile communication device). In some implementations, receiving data gathered through a process running on a content site indicative of communication between the content site and a computing device responsive to a human user input (at 772) may include receiving beneficiary site data indicative of at least one of communication associated with a purchase, communication associated with a vote, communication associated with a fund raising, and/or communication associated with a transaction between the computing device and the beneficiary site at 784 (e.g. receiving contribution records from a radio station, such as a publicly-funded radio station, indicative of a donation associated provided from the computing device to the radio station).

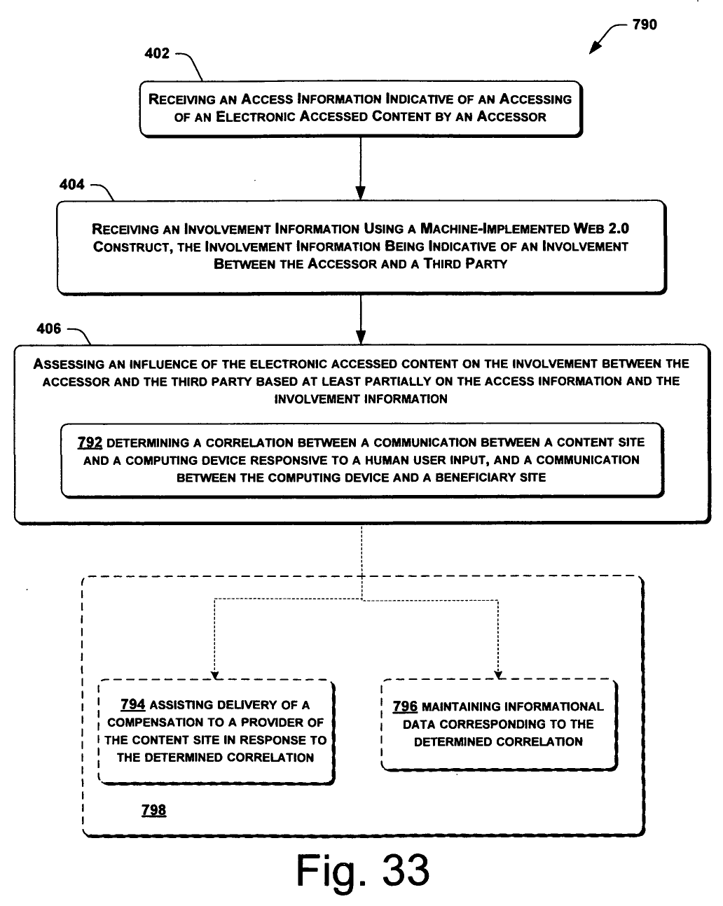

As shown in FIG. 33, in some implementations such as a process 790, assessing an influence of the electronic accessed content on the involvement between the accessor and the third party based at least partially on the access information and the involvement information (at 406) may include determining a correlation between a communication between a content site and a computing device responsive to a human user input, and a communication between the computing device and a beneficiary site at 792 (e.g determining a high-probability correlation between a consumer viewing a product review on a site of an information broker and the consumer's subsequent purchase of the product and an on-line retail site). In some implementations, the process 790 may further include assisting delivery of a compensation to a provider of the content site in response to the determined correlation at 794 (e.g. performing an online deposit to a bank account of an owner of electronic assessed content based on a high-probability correlation), or maintaining informational data corresponding to the determined correlation at 796 (e.g. storing data regarding purchase-and-sale transaction correlations in a memory), or both at 798.

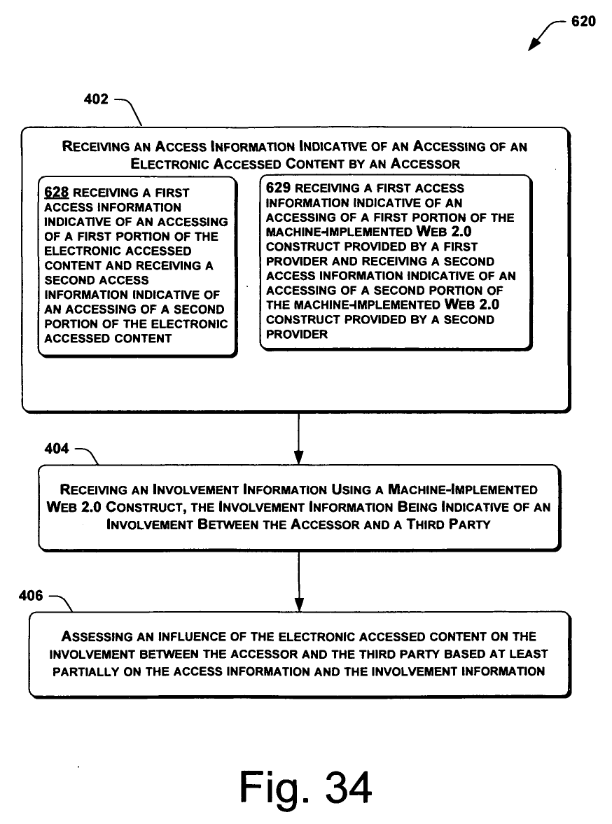

It may be noted that receiving an access information indicative of an accessing of an electronic accessed content by an accessor (at 402 of FIG. 5) may occur in other ways. For example, in some implementations, such as a process 620 shown in FIG. 34, receiving an access information indicative of an accessing of an electronic accessed content by an accessor (at 402) may include receiving a first access information indicative of an accessing of a first portion of the electronic accessed content and receiving a second access information indicative of an accessing of a second portion of the electronic accessed content at 628 (e.g. receiving first data indicative of an accessing of a first product review of an aggregation of product reviews and receiving a second data indicative of an accessing of a second product review of the aggregation of product reviews). Similarly, in some implementations, receiving an access information indicative of an accessing of an electronic accessed content by an accessor (at 402) may include receiving a first access information indicative of an accessing of a first portion of a machine-implemented Web 2.0 construct provided by a first provider and receiving a second access information indicative of an accessing of a second portion of the machine-implemented Web 2.0 construct provided by a second provider at 629 (e.g. receiving first data indicative of an accessing of a web service portion of a mashup of content, and receiving second data indicative of an accessing of a Flash application portion of the mashup of content).

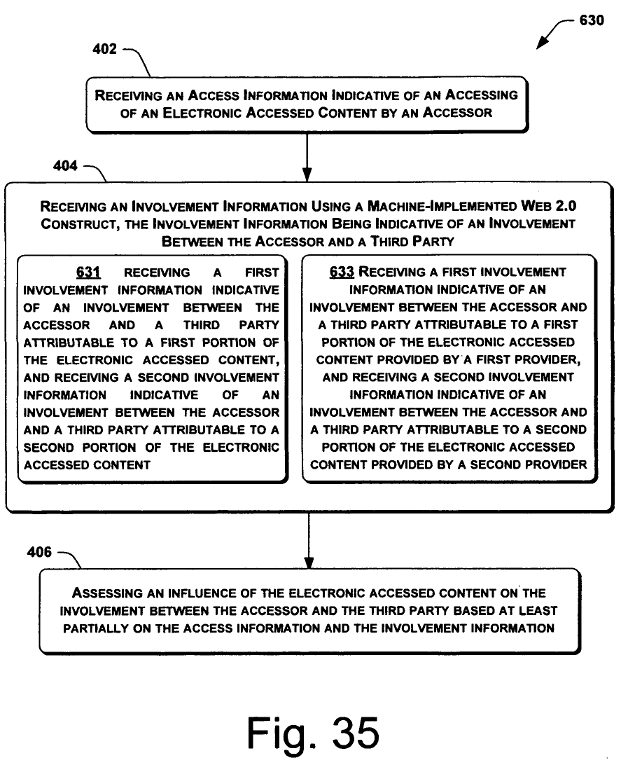

Similarly, receiving an involvement information using a machine-implemented Web 2.0 construct, the involvement information being indicative of an involvement between the accessor and a third party (at 404 of FIG. 5) may be accomplished in a variety of additional ways. For example, in some implementations, such as a process 630 shown in FIG. 35, receiving an involvement information using a machine-implemented Web 2.0 construct, the involvement information being indicative of an involvement between the accessor and a third party (at 404) may include receiving a first involvement information indicative of an involvement between the accessor and a third party attributable to a first portion of the electronic accessed content and receiving a second involvement information indicative of an involvement between the accessor and a third party attributable to a second portion of the electronic accessed content at 631 (e.g. receiving first data indicative of a first period spent by a consumer shopping at an online retail facility attributable to a first article from an aggregation of product-related articles, and receiving second data indicative of a second period spent by the consumer shopping at the online retail facility attributable to a second article from the aggregation). Similarly, in further implementations receiving an involvement information using a machine-implemented Web 2.0 construct, the involvement information being indicative of an involvement between the accessor and a third party (at 404) may include receiving a first involvement information indicative of an involvement between the accessor and a third party attributable to a first portion of the electronic accessed content provided by a first provider and receiving a second involvement information indicative of an involvement between the accessor and a third party attributable to a second portion of the electronic accessed content provided by a second provider at 633 (e.g receiving first data indicative of a first surfing period spent by a potential soldier surfing information on goarmy.com attributable to a first promotional piece of an aggregation of pieces provided by a former soldier, and receiving second data indicative of a second surfing period spent by the potential soldier attributable to a second promotional piece of the aggregation provided by a current soldier).

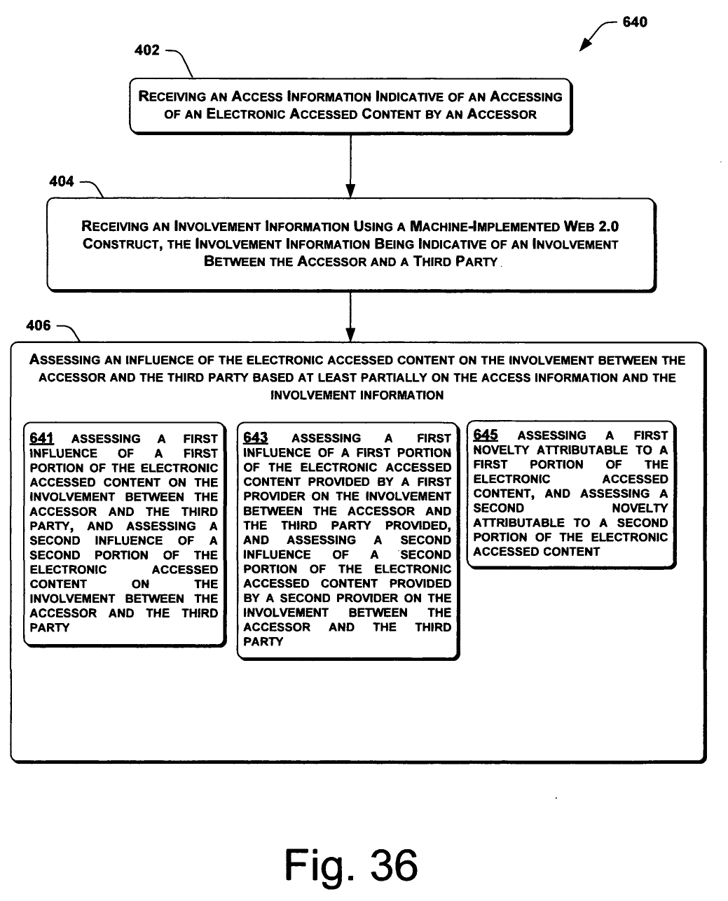

In still other implementations, assessing an influence of the electronic accessed content on the involvement between the accessor and the third party based at least partially on the access information and the involvement information (e.g., at 406) may be accomplished in a variety of ways. For example, in some implementations, such as a process 640 shown in FIG. 36, assessing an influence of the electronic accessed content on the involvement between the accessor and the third party based at least partially on the access information and the involvement information (at 406) may include assessing a first influence of a first portion of the electronic accessed content on the involvement between the accessor and the third party and assessing a second influence of a second portion of the electronic accessed content on the involvement between the accessor and the third party at 641 (e.g. assessing a first influence of a first product review from a consumer e-magazine on an automobile purchase between a buyer and a dealership and assessing a second influence of a second product review from the consumer e-magazine on the automobile purchase). In further implementations, assessing an influence of the electronic accessed content on the involvement between the accessor and the third party based at least partially on the access information and the involvement information (at 406) may include assessing a first influence of a first portion of the electronic accessed content provided by a first provider on the involvement between the accessor and the third party provided and assessing a second influence of a second portion of the electronic accessed content provided by a second provider on the involvement between the accessor and the third party at 643 (e.g. assessing a first influence of a first product review from a consumer e-magazine provided by a consumer watchdog group on an automobile purchase between a buyer and a dealership and assessing a second influence of a second product review from the consumer e-magazine provided by an automotive test group on the automobile purchase). Similarly, assessing an influence of the electronic accessed content on the involvement between the accessor and the third party based at least partially on the access information and the involvement information (at 406) may include assessing a first novelty attributable to a first portion of the electronic accessed content and assessing a second novelty attributable to a second portion of the electronic accessed content at 645 (e.g. assessing a first novelty attributable to a first product review from a consumer e-magazine and assessing a second novelty attributable to a second product review from the consumer e-magazine).

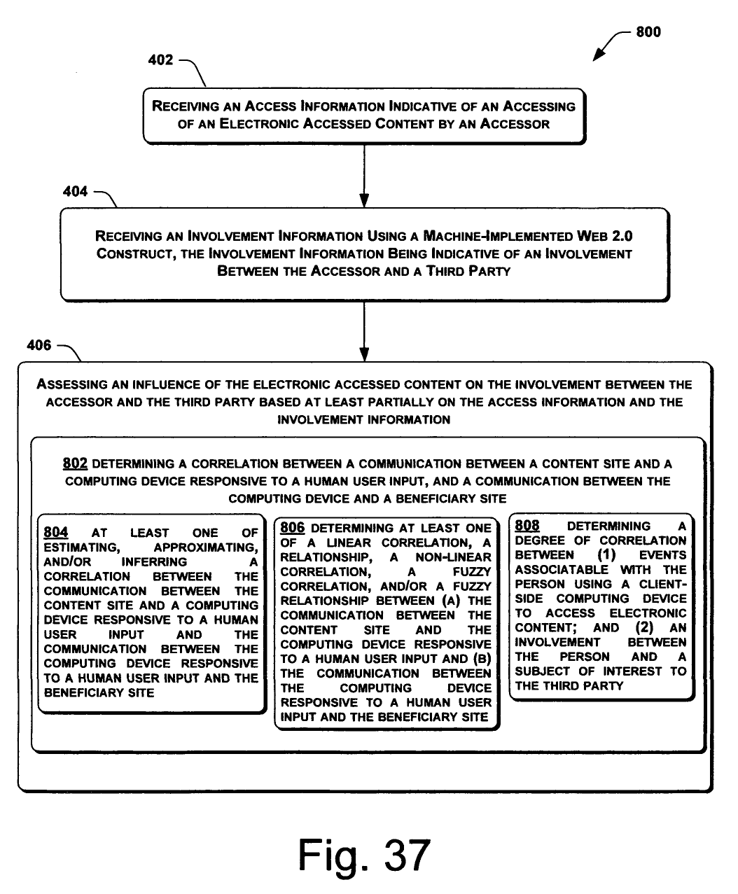

As illustrated in FIG. 37, in some implementations (e.g. process 800), assessing an influence of the electronic accessed content on the involvement between the accessor and the third party based at least partially on the access information and the involvement information (at 406) may include determining a correlation between a communication between a content site and a computing device responsive to a human user input, and a communication between the computing device and a beneficiary site at 802 (e.g. determining that a download regarding rental products from a server to a handheld device is correlated to a rental of the rental product from a rental provider). More specifically, in some implementations, determining a correlation between a communication between a content site and a computing device responsive to a human user input, and a communication between the computing device and a beneficiary site (at 802) may include at least one of estimating, approximating, and/or inferring a correlation between the communication between the content site and a computing device responsive to a human user input and the communication between the computing device responsive to a human user input and the beneficiary site at 804 (e.g. inferring that an upload regarding the attributes of product A from a server to a handheld device is correlated to a purchase of product A from a retailer).

Similarly, determining a correlation between a communication between a content site and a computing device responsive to a human user input, and a communication between the computing device and a beneficiary site (at 802) may include determining at least one of a linear correlation, a relationship, a non-linear correlation, a fuzzy correlation, and/or a fuzzy relationship between (a) the communication between the content site and the computing device responsive to a human user input and (b) the communication between the computing device responsive to a human user input and the beneficiary site at 806 (e.g. determining that a length of time spent by the accessor browsing a content regarding the attributes of product A is linearly related to a purchase of product A by the accessor from a retailer). In further implementations, determining a correlation between a communication between a content site and a computing device responsive to a human user input, and a communication between the computing device and a beneficiary site (at 802) may include determining a degree of correlation between (1) events associatable with the person using a client-side computing device to access electronic content; and (2) an involvement between the person and a subject of interest to the third party at 808 (e.g. determining a strong correlation between an accessor's browsing of content regarding the attributes of service X and the accessor's subsequent purchase of service Y from a service retailer).

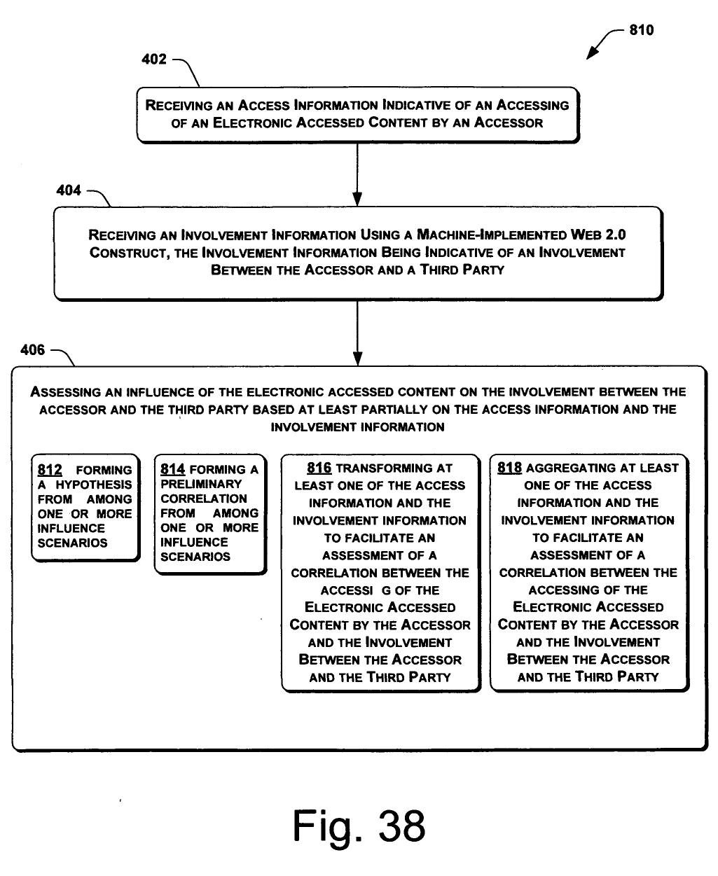

In still other implementations, such as a process 810 shown in FIG. 38, assessing an influence of the electronic accessed content on the involvement between the accessor and the third party based at least partially on the access information and the involvement information (at 406) may include forming a hypothesis from among one or more influence scenarios at 812 (e.g. forming a hypothesis that the accessor was strongly influenced from among several possible influence levels). Similarly, assessing an influence of the electronic accessed content on the involvement between the accessor and the third party based at least partially on the access information and the involvement information (at 406) may include assessing a first influence of a first electronic accessed content provided by a first provider based at least partially on the first access information at 814 (e.g. deciding that the accessor's involvement is strongly correlated with the involvement from among several possible correlation levels).

In other implementations, assessing an influence of the electronic accessed content on the involvement between the accessor and the third party based at least partially on the access information and the involvement information (at 406) may include transforming at least one of the access information and the involvement information to facilitate an assessment of a correlation between the accessing of the electronic accessed content by the accessor and the involvement between the accessor and the third party at 816 (e.g. filtering outlying instances of the access information and the involvement information to improve the correlation assessment between the accessing and the involvement). Further, assessing an influence of the electronic accessed content on the involvement between the accessor and the third party based at least partially on the access information and the involvement information (at 406) may include aggregating at least one of the access information and the involvement information to facilitate an assessment of a correlation between the accessing of the electronic accessed content by the accessor and the involvement between the accessor and the third party at 818 (e.g. compiling historical data regarding the access information and the involvement information to improve the correlation assessment between the accessing and the involvement).

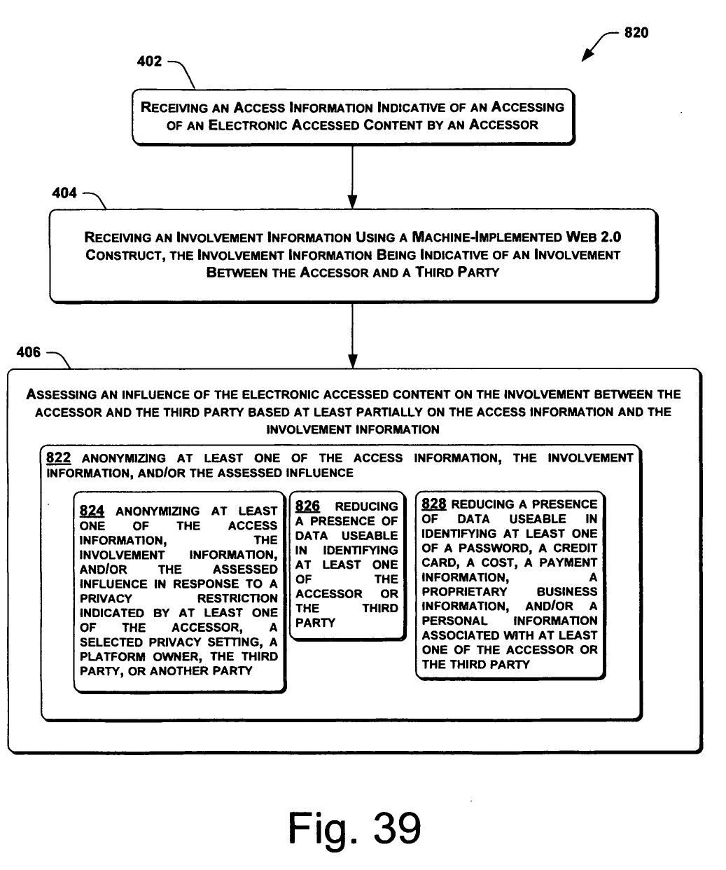

In some implementations, such as a process 820 shown in FIG. 39, assessing an influence of the electronic accessed content on the involvement between the accessor and the third party based at least partially on the access information and the involvement information (at 406) may include anonymizing at least one of the access information, the involvement information, and/or the assessed influence at 822 (e.g. deleting identifying information regarding an identity of the accessor from the access information and the involvement information). More specifically, anonymizing at least one of the access information, the involvement information, and/or the assessed influence (at 822) may include anonymizing at least one of the access information, the involvement information, and/or the assessed influence in response to a privacy restriction indicated by at least one of the accessor, a selected privacy setting, a platform owner, the third party, or another party at 824 (e.g. deleting identifying information regarding an identity of the accessor from the access information and the involvement information in accordance with a privacy policy election by the accessor).

In other implementations, anonymizing at least one of the access information, the involvement information, and/or the assessed influence (at 822) may include reducing a presence of data useable in identifying at least one of the accessor or the third party at 826 (e.g. generalizing identity information regarding the accessor to a general type of accessor, and generalizing identity information regarding the third party to a general type of third party, from the access information and the involvement information). In further implementations, anonymizing at least one of the access information, the involvement information, and/or the assessed influence (at 822) may include reducing a presence of data useable in identifying at least one of a password, a credit card, a cost, a payment information, a proprietary business information, and/or a personal information associated with at least one of the accessor or the third party at 828 (e.g. redacting information regarding details of a consumer transaction between the accessor and the third party from the access information and the involvement information).

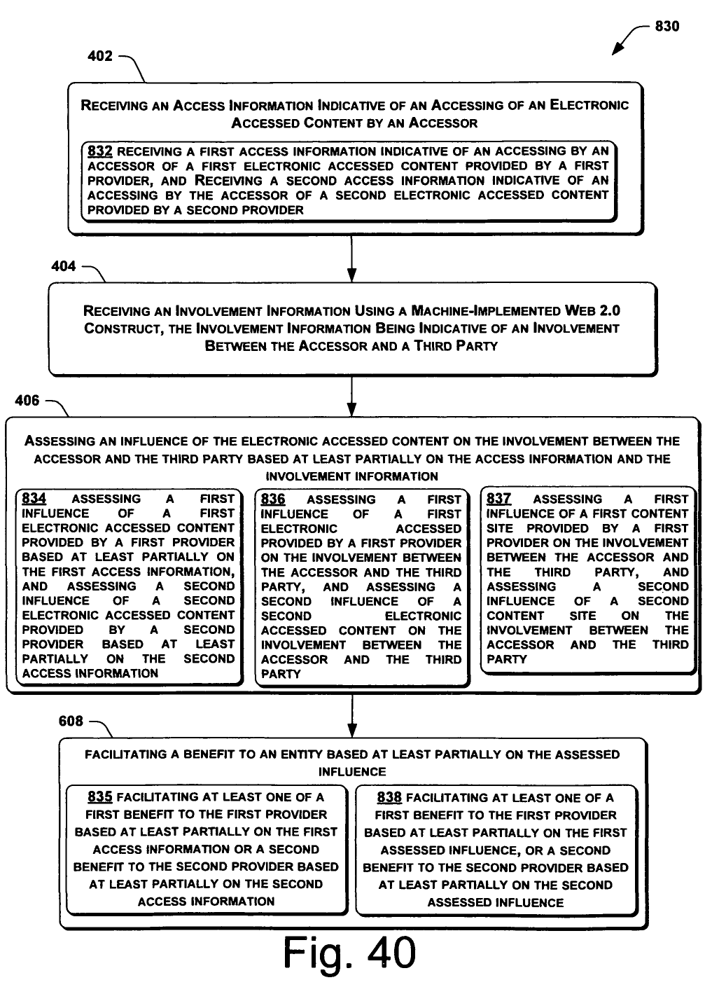

In yet another implementation, a process 830 shown in FIG. 40 may include receiving an access information indicative of an accessing of an electronic accessed content by an accessor at 402 (e.g. receiving “hit,” access time, or “cursor hovering” information associated with an accessor), receiving an involvement information using a machine-implemented Web 2.0 construct, the involvement information being indicative of an involvement between the accessor and a third party at 404 (e.g. receiving information indicating a commercial transaction between a consumer and a provider), assessing an influence of the electronic accessed content on the involvement between the accessor and the third party based at least partially on the access information and the involvement information at 406 (e.g. assessing that the accessed content had a moderate influence on the commercial transaction between a consumer and a provider), and facilitating a benefit to an entity based at least partially on the assessed influence at 608 (e.g. adding points to an account of a provider of the accessed content commensurate with the moderate influence).

More specifically, in some implementations, receiving an access information indicative of an accessing of an electronic accessed content by an accessor (at 402) may include receiving a first access information indicative of an accessing by an accessor of a first electronic accessed content provided by a first provider and receiving a second access information indicative of an accessing by the accessor of a second electronic accessed content provided by a second provider at 832. Similarly, assessing an influence of the electronic accessed content on the involvement between the accessor and the third party based at least partially on the access information and the involvement information (at 406) may include assessing a first influence of a first electronic accessed content provided by a first provider based at least partially on the first access information and assessing a second influence of a second electronic accessed content provided by a second provider based at least partially on the second access information at 834. And in some implementations, facilitating a benefit to an entity based at least partially on the assessed influence (at 608) may include facilitating at least one of a first benefit to the first provider based at least partially on the first access information, or a second benefit to the second provider based at least partially on the second access information at 834.

As further shown in FIG. 40, in other implementations, assessing an influence of the electronic accessed content on the involvement between the accessor and the third party based at least partially on the access information and the involvement information (at 406) may include assessing a first influence of a first electronic accessed content provided by a first provider on the involvement between the accessor and the third party and assessing a second influence of a second electronic accessed content provided by a second provider on the involvement between the accessor and the third party at 836. Similarly, in some implementations, assessing an influence of the electronic accessed content on the involvement between the accessor and the third party based at least partially on the access information and the involvement information (at 406) may include assessing a first influence of a first content site provided by a first provider on the involvement between the accessor and the third party and assessing a second influence of a second content site provided by a second provider on the involvement between the accessor and the third party at 837. In addition, facilitating a benefit to an entity based at least partially on the assessed influence at 608 may include facilitating delivery of at least one of a first benefit to the first provider based at least partially on the first assessed influence, or a second benefit to the second provider based at least partially on the second assessed influence at 838.

It should be appreciated that the particular embodiments of systems and processes described herein are merely possible implementations of the present disclosure, and that the present disclosure is not limited to the particular implementations described herein and shown in the accompanying figures. For example, in alternate implementations, certain acts need not be performed in the order described, and may be modified, and/or may be omitted entirely, depending on the circumstances. Moreover, in various implementations, the acts described may be implemented by a computer, controller, processor, programmable device, or any other suitable device, and may be based on instructions stored on one or more computer-readable media or otherwise stored or programmed into such devices. In the event that computer-readable media are used, the computer-readable media can be any available media that can be accessed by a device to implement the instructions stored thereon.

Various methods, systems, and techniques may be described and implemented in the general context of computer-executable instructions, such as program modules, executed by one or more processors or other devices. Generally, program modules include routines, programs, objects, components, data structures, etc. that perform particular tasks or implement particular abstract data types. Typically, the functionality of the program modules may be combined or distributed as desired in various alternate embodiments. In addition, embodiments of these methods, systems, and techniques may be stored on or transmitted across some form of computer readable media.

It may also be appreciated that there may be little distinction between hardware and software implementations of aspects of systems and methods disclosed herein. The use of hardware or software may generally be a design choice representing cost vs. efficiency tradeoffs, however, in certain contexts the choice between hardware and software can become significant. Those having skill in the art will appreciate that there are various vehicles by which processes, systems, and technologies described herein can be effected (e.g., hardware, software, firmware, or combinations thereof), and that a preferred vehicle may vary depending upon the context in which the processes, systems, and technologies are deployed. For example, if an implementer determines that speed and accuracy are paramount, the implementer may opt for a mainly hardware and/or firmware vehicle. Alternatively, if flexibility is paramount, the implementer may opt for a mainly software implementation. In still other implementations, the implementer may opt for some combination of hardware, software, and/or firmware. Hence, there are several possible vehicles by which the processes and/or devices and/or other technologies described herein may be effected, and which may be desired over another may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use standard engineering practices to integrate such described devices and/or processes into workable systems having the described functionality. That is, at least a portion of the devices and/or processes described herein can be developed into a workable system via a reasonable amount of experimentation.

The herein described aspects and drawings illustrate different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” (or “operatively connected,” or “operatively coupled”) to each other to achieve the desired functionality, and any two components capable of being so associated can also be viewed as being “operably couplable” (or “operatively couplable”) to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that some aspects of the embodiments disclosed herein can be implemented in standard integrated circuits, and also as one or more computer programs running on one or more computers, and also as one or more software programs running on one or more processors, and also as firmware, as well as virtually any combination thereof. It will be further understood that designing the circuitry and/or writing the code for the software and/or firmware could be accomplished by a person skilled in the art in light of the teachings and explanations of this disclosure.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. For example, in some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g, as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

As a further example of “open” terms in the present specification and claims, it will be understood that usage of a language construction “A or B” is generally interpreted as a non-exclusive “open term” meaning: A alone, B alone, and/or A and B together.

Although various features have been described in considerable detail with reference to certain preferred embodiments, other embodiments are possible. Therefore, the spirit or scope of the appended claims should not be limited to the description of the embodiments contained herein.

1. An influence evaluation method, comprising:
receiving an access information indicative of an accessing of an electronic accessed content by an accessor;
receiving an involvement information using a machine-implemented Web 2.0 construct, the involvement information being indicative of an involvement between the accessor and a third party; and
assessing an influence of the electronic accessed content on the involvement between the accessor and the third party based at least partially on the access information and the involvement information.

2. The method of claim 1, wherein receiving an access information indicative of an accessing of an electronic accessed content by an accessor comprises:
receiving data indicative of an accessor accessing at least one of a first network-available electronic content having a first electronic-content portion or a second network-available electronic content having a second electronic-content portion.

3. (canceled)

4. (canceled)

5. (canceled)

6. (canceled)

7. The method of claim 1, wherein receiving an involvement information using a machine-implemented Web 2.0 construct, the involvement information being indicative of an involvement between the accessor and a third party comprises:
receiving data using a machine-implemented Web 2.0 construct indicative of at least one of an activity, interaction, purchase, vote, contribution, and/or relationship between the accessor and the third-party.

8. The method of claim 1, wherein receiving an involvement information using a machine-implemented Web 2.0 construct, the involvement information being indicative of an involvement between the accessor and a third party comprises:
receiving data using a machine-implemented Web 2.0 construct indicative of a behavior by the accessor with respect to the third-party.

9. The method of claim 1, wherein receiving an involvement information using a machine-implemented Web 2.0 construct, the involvement information being indicative of an involvement between the accessor and a third party comprises:
receiving data using a machine-implemented Web 2.0 construct useable in inferring an involvement between the accessor and the third-party.

10. The method of claim 1, wherein receiving an involvement information using a machine-implemented Web 2.0 construct, the involvement information being indicative of an involvement between the accessor and a third party comprises:
asynchronously receiving an involvement information using a machine-implemented Web 2.0 construct, the involvement information being indicative of an involvement between the accessor and a third party.

11. The method of claim 1, wherein receiving an involvement information using a machine-implemented Web 2.0 construct, the involvement information being indicative of an involvement between the accessor and a third party comprises:
receiving an involvement information using a web service.

12. (canceled)

13. The method of claim 1, wherein receiving an involvement information using a machine-implemented Web 2.0 construct, the involvement information being indicative of an involvement between the accessor and a third party comprises:
receiving an involvement information using an Ajax (Asynchronous JavaScript and XML (Extensible Markup Language)) application.

14. (canceled)

15. The method of claim 1, wherein receiving an involvement information using a machine-implemented Web 2.0 construct, the involvement information being indicative of an involvement between the accessor and a third party comprises:
receiving an involvement information using a Flash application.

16. (canceled)

17. The method of claim 1, wherein receiving an involvement information using a machine-implemented Web 2.0 construct, the involvement information being indicative of an involvement between the accessor and a third party comprises:
receiving an involvement information using a mashup that includes the electronic accessed content and at least one of a web service, an Ajax application, a Flash application, an electronic content, or another electronic accessed content.

18. (canceled)

19. (canceled)

20. (canceled)

21. The method of claim 1, wherein receiving an access information indicative of an accessing of an electronic accessed content by an accessor comprises:
receiving an access information indicative of an accessing by an accessor of at least one of a digital content, a textual content, a graphical content, an audio content, a pictoral content, a video content, a streaming content, an RSS (Really Simple Syndication) content, an HTML (HyperText Markup Language) content, an XML (Extensible Markup Language) content, a human-perceivable content, or a machine-readable content.

22. (canceled)

23. The method of claim 1, wherein receiving an access information indicative of an accessing of an electronic accessed content by an accessor comprises:
receiving an access information indicative of an accessing of a machine-implemented Web 2.0 construct by an accessor.

24. The method of claim 23, wherein receiving an access information indicative of an accessing of a machine-implemented Web 2.0 construct by an accessor comprises:
receiving an access information indicative of an accessing of a web service by an accessor.

25. (canceled)

26. The method of claim 23, wherein receiving an access information indicative of an accessing of a machine-implemented Web 2.0 construct by an accessor comprises:
receiving an access information indicative of an accessing of an Ajax (Asynchronous JavaScript and XML (Extensible Markup Language)) application by an accessor.

27. The method of claim 23, wherein receiving an access information indicative of an accessing of a machine-implemented Web 2.0 construct by an accessor comprises:
receiving an access information indicative of an accessing by an accessor of a mashup that includes at least one Ajax application.

28. (canceled)

29. The method of claim 23, wherein receiving an access information indicative of an accessing of a machine-implemented Web 2.0 construct by an accessor comprises:
receiving an access information indicative of an accessing by an accessor of a mashup that includes at least one Flash application.

30. (canceled)

31. The method of claim 23, wherein receiving an access information indicative of an accessing of a machine-implemented Web 2.0 construct by an accessor comprises:
receiving an access information indicative of an accessing by an accessor of a mashup that includes at least one Web 2.0 electronic content.

32. (canceled)

33. The method of claim 23, wherein receiving an access information indicative of an accessing of a machine-implemented Web 2.0 construct by an accessor comprises:
receiving an access information indicative of an accessing of an open-source machine-implemented Web 2.0 construct by an accessor.

34. (canceled)

35. (canceled)

36. The method of claim 23, wherein receiving an access information indicative of an accessing of a machine-implemented Web 2.0 construct by an accessor comprises:
receiving an access information indicative of an accessing by an accessor of a combination of a web service and an electronic content.

37. (canceled)

38. (canceled)

39. (canceled)

40. (canceled)

41. (canceled)

42. The method of claim 1, further comprising:
providing the electronic accessed content for access by the accessor.

43. (canceled)

44. (canceled)

45. (canceled)

46. (canceled)

47. (canceled)

48. (canceled)

49. (canceled)

50. (canceled)

51. (canceled)

52. (canceled)

53. The method of claim 42, wherein providing the electronic accessed content for access by the accessor comprises:
providing the electronic accessed content for access by the accessor via an engine loaded locally relative to the accessor.

54. The method of claim 53, wherein providing the electronic accessed content for access by the accessor via an engine loaded locally relative to the accessor comprises:
providing the electronic accessed content for access by the accessor via an Ajax application loaded locally relative to the accessor.

55. The method of claim 42, wherein providing the electronic accessed content for access by the accessor comprises:
providing the electronic accessed content for access by the accessor via an engine operable to render an interface accessible to the accessor.

56. The method of claim 42, wherein providing the electronic accessed content for access by the accessor comprises:
providing the electronic accessed content for access by the accessor via an engine operable to communicate with a server that hosts the electronic accessed content.

57. The method of claim 42, wherein providing the electronic accessed content for access by the accessor comprises:
mashing up the electronic accessed content with at least one of a web service, an Ajax application, a Flash application, an electronic content, or another electronic accessed content.

58. The method of claim 1, wherein receiving an access information indicative of an accessing of an electronic accessed content by an accessor comprises:
receiving an access information from a monitoring component that is external relative to a provider of the electronic accessed content.

59. The method of claim 1, wherein receiving an access information indicative of an accessing of an electronic accessed content by an accessor comprises:
receiving an access information from a monitoring component that is local relative to a provider of the electronic accessed content.

60. (canceled)

61. (canceled)

62. (canceled)

63. (canceled)

64. The method of claim 1, wherein assessing an influence of the electronic accessed content on the involvement between the accessor and the third party based at least partially on the access information and the involvement information comprises:
determining the assessed influence using an assessment component that is external relative to a provider of the electronic accessed content.

65. The method of claim 1, wherein assessing an influence of the electronic accessed content on the involvement between the accessor and the third party based at least partially on the access information and the involvement information comprises:
determining the assessed influence using an assessment component that is local relative to a provider of the electronic accessed content.

66. The method of claim 1, wherein assessing an influence of the electronic accessed content on the involvement between the accessor and the third party based at least partially on the access information and the involvement information comprises:
determining the assessed influence using an engine loaded locally relative to the accessor.

67. The method of claim 1, wherein assessing an influence of the electronic accessed content on the involvement between the accessor and the third party based at least partially on the access information and the involvement information comprises:
determining the assessed influence using an Ajax application loaded locally relative to the accessor.

68. The method of claim 1, wherein assessing an influence of the electronic accessed content on the involvement between the accessor and the third party based at least partially on the access information and the involvement information comprises:
determining the assessed influence using an engine operable to render an interface accessible to the accessor.

69. The method of claim 1, wherein assessing an influence of the electronic accessed content on the involvement between the accessor and the third party based at least partially on the access information and the involvement information comprises:
determining the assessed influence using an engine operable to communicate with a server that hosts the electronic accessed content.

70. The method of claim 1, further comprising:
providing an indication of the assessed influence.

71. The method of claim 70, wherein providing an indication of the assessed influence comprises:
providing an indication of the assessed influence for determining a benefit to a provider of the electronic accessed content.

72. (canceled)

73. (canceled)

74. The method of claim 70, wherein providing an indication of the assessed influence comprises:
providing an indication of the assessed influence to a component operable to determine a benefit to a provider of the electronic accessed content.

75. The method of claim 74, wherein providing an indication of the assessed influence to a component operable to determine a benefit to a provider of the electronic accessed content comprises:
providing an indication of the assessed influence to an entity operable to determine a benefit to at least one of a creator of the electronic accessed content, an owner of the electronic accessed content, an aggregator of the electronic accessed content, a provider of the electronic accessed content, a facilitator of the electronic accessed content, or a host of the electronic accessed content.

76. The method of claim 1, further comprising:
facilitating a benefit to an entity based at least partially on the assessed influence.

77. The method of claim 76, wherein facilitating a benefit to an entity based at least partially on the assessed influence comprises:
facilitating delivery of at least one of a compensation, privilege, and/or reward to at least one of an owner of a first electronic content or an owner of a second electronic content in response to the assessed influence.

78. The method of claim 76, wherein facilitating a benefit to an entity based at least partially on the assessed influence comprises:
facilitating delivery of a benefit to an owner of a first electronic content or an owner of a second electronic content in response to the assessed influence by a first electronic-content and/or a second electronic-content on the involvement between the accessor and the third-party, a measure of the benefit determined by at least one of another accessor, and/or the third-party.

79. (canceled)

80. (canceled)

81. (canceled)

82. (canceled)

83. The method of claim 76, wherein facilitating a benefit to an entity based at least partially on the assessed influence comprises:
facilitating delivery of a benefit to an owner of a first electronic content or an owner of a second electronic content in response to the assessed influence by the first electronic content and/or the second electronic content on the involvement between the accessor and the third-party.

84. (canceled)

85. (canceled)

86. (canceled)

87. (canceled)

88. The method of claim 1, further comprising:
facilitating a benefit to at least one entity based at least partially on at least one of a first influence attributable to a first portion of the electronic accessed content and a second influence attributable to a second portion of the electronic accessed content.

89. The method of claim 88, wherein facilitating a benefit to at least one entity based at least partially on at least one of a first influence attributable to a first portion of the electronic accessed content and a second influence attributable to a second portion of the electronic accessed content comprises:
facilitating a first benefit to a first provider of a first portion of the electronic accessed content based at least partially on a first influence; and
facilitating a second benefit to a second provider of a second portion of the electronic accessed content based at least partially on a second influence.

90. (canceled)

91. The method of claim 88, wherein facilitating a benefit to at least one entity based at least partially on at least one of a first influence attributable to a first portion of the electronic accessed content and a second influence attributable to a second portion of the electronic accessed content comprises:
determining a difference between a first benefit provided to a first provider of a first portion of the electronic accessed content and a second benefit provided to a second provider of a second portion of the electronic accessed content based at least partially on a novelty attributable to at least one of the first and second portions of the electronic accessed content.

92. The method of claim 1, wherein receiving an involvement information using a machine-implemented Web 2.0 construct, the involvement information being indicative of an involvement between the accessor and a third party comprises:
receiving data indicative of an affinity of the accessor.

93. (canceled)

94. (canceled)

95. The method of claim 1, wherein receiving an involvement information using a machine-implemented Web 2.0 construct, the involvement information being indicative of an involvement between the accessor and a third party comprises:
receiving data gathered through a process running on a content site indicative of communication between the content site and a computing device responsive to a human user input.

96. (canceled)

97. (canceled)

98. (canceled)

99. (canceled)

100. (canceled)

101. The method of claim 1, wherein assessing an influence of the electronic accessed content on the involvement between the accessor and the third party based at least partially on the access information and the involvement information comprises:
determining a correlation between a communication between a content site and a computing device responsive to a human user input, and a communication between the computing device and a beneficiary site.

102. (canceled)

103. (canceled)

104. (canceled)

105. The method of claim 1, wherein receiving an access information indicative of an accessing of an electronic accessed content by an accessor comprises:
receiving a first access information indicative of an accessing of a first portion of a machine-implemented Web 2.0 construct provided by a first provider; and
receiving a second access information indicative of an accessing of a second portion of the machine-implemented Web 2.0 construct provided by a second provider.

106. (canceled)

107. (canceled)

108. The method of claim 1, wherein assessing an influence of the electronic accessed content on the involvement between the accessor and the third party based at least partially on the access information and the involvement information comprises:
assessing a first influence of a first portion of the electronic accessed content on the involvement between the accessor and the third party; and
assessing a second influence of a second portion of the electronic accessed content on the involvement between the accessor and the third party.

109. (canceled)

110. The method of claim 1, wherein assessing an influence of the electronic accessed content on the involvement between the accessor and the third party based at least partially on the access information and the involvement information comprises:
assessing a first novelty attributable to a first portion of the electronic accessed content; and
assessing a second novelty attributable to a second portion of the electronic accessed content.

111. The method of claim 1, wherein assessing an influence of the electronic accessed content on the involvement between the accessor and the third party based at least partially on the access information and the involvement information comprises:
determining a correlation between a communication between a content site and a computing device responsive to a human user input, and a communication between the computing device and a beneficiary site.

112. (canceled)

113. (canceled)

114. (canceled)

115. (canceled)

116. (canceled)

117. The method of claim 1, wherein assessing an influence of the electronic accessed content on the involvement between the accessor and the third party based at least partially on the access information and the involvement information comprises:
transforming at least one of the access information and the involvement information to facilitate an assessment of a correlation between the accessing of the electronic accessed content by the accessor and the involvement between the accessor and the third party.

118. (canceled)

119. The method of claim 1, wherein assessing an influence of the electronic accessed content on the involvement between the accessor and the third party based at least partially on the access information and the involvement information comprises:
anonymizing at least one of the access information, the involvement information, and/or the assessed influence.

120. (canceled)

121. (canceled)

122. (canceled)

123. (canceled)

124. (canceled)

125. (canceled)

126. (canceled)

127. The method of claim 1, wherein assessing an influence of the electronic accessed content on the involvement between the accessor and the third party based at least partially on the access information and the involvement information comprises:
assessing a first influence of a first electronic accessed content provided by a first provider on the involvement between the accessor and the third party; and
assessing a second influence of a second electronic accessed content provided by a second provider on the involvement between the accessor and the third party.

128. The method of claim 1, wherein assessing an influence of the electronic accessed content on the involvement between the accessor and the third party based at least partially on the access information and the involvement information comprises:
assessing a first influence of a first content site provided by a first provider on the involvement between the accessor and the third party; and
assessing a second influence of a second content site provided by a second provider on the involvement between the accessor and the third party.

129. The method of claim 127, further comprising:
facilitating a benefit to an entity based at least partially on the assessed influence.

130. (canceled)

131. An influence evaluation apparatus, comprising:
means for receiving an access information indicative of an accessing of an electronic accessed content by an accessor;
means for receiving an involvement information using a machine-implemented Web 2.0 construct, the involvement information being indicative of an involvement between the accessor and a third party; and
means for assessing an influence of the electronic accessed content on the involvement between the accessor and the third party based at least partially on the access information and the involvement information.

132-260. (canceled)

261. A system, comprising:
circuitry for receiving an access information indicative of an accessing of an electronic accessed content by an accessor;
circuitry for receiving an involvement information using a machine-implemented Web 2.0 construct, the involvement information being indicative of an involvement between the accessor and a third party; and
circuitry for assessing an influence of the electronic accessed content on the involvement between the accessor and the third party based at least partially on the access information and the involvement information.

262. A computer program product, comprising:
a signal bearing medium bearing instructions for:
receiving an access information indicative of an accessing of an electronic accessed content by an accessor;
receiving an involvement information using a machine-implemented Web 2.0 construct, the involvement information being indicative of an involvement between the accessor and a third party; and
assessing an influence of the electronic accessed content on the involvement between the accessor and the third party based at least partially on the access information and the involvement information.
